(19) United States
(12) Patent Application Publication
(10) Pub. No.: US 2010/0239786 A1
(43) Pub. Date: Sep. 23, 2010

(54) CELLULOSE ACYLATE FILM AND METHOD FOR PRODUCING SAME, RETARDATION FILM, POLARIZER AND LIQUID-CRYSTAL DISPLAY DEVICE

(76) Inventors: Jun Takeda, Kanagawa (JP); Yuki Matsuda, Kanagawa (JP); Hiroyuki Kawanishi, Kanagawa (JP); Hiromichi Tachikawa, Kanagawa (JP)

Correspondence Address: BIRCH STEWART KOLASCH & BIRCH, PO BOX 747, FALLS CHURCH, VA, 22040-0747, US

(21) Appl. No.: 12/728,539

(22) Filed: Mar. 22, 2010

(30) Foreign Application Priority Data
Mar. 23, 2009 (JP) 2009-69700

(51) Int. Cl. C09K 19/00; C08B 3/00; B29C 55/00

(52) U.S. Cl. 428/1.1; 536/63; 264/291

(57) ABSTRACT

A cellulose acylate film of which the difference between the in-plane retardation at a wavelength of 630 nm and the in-plane retardation at a wavelength of 450 nm is 1 to 15 nm, and satisfying the following formula (2) both in the film traveling direction and in the direction perpendicular thereto:

−0.5%≦{(L′−L0)/L0}×100≦0.5% (2),

wherein L0 means the length of the film before the lapse of time of 24 hours at 60° C. and 90% RH; and L′ means the length of the film after the lapse of time of 24 hours at 60° C. and 90% RH followed by humidity conditioning for 2 hours.

### CROSS-REFERENCE TO RELATED APPLICATIONS

The present application claims the benefit of priority from Japanese Patent Application No. 2009-69700, filed on Mar. 23, 2009, the contents of which are herein incorporated by reference in their entirety.

### BACKGROUND OF THE INVENTION

1. Field of the Invention

The present invention relates to a cellulose acylate film improved in the humidity stability and the wet heat durability and to its production method. The invention also relates to a retardation film, a polarizer and a liquid-crystal display device comprising the film.

2. Description of the Related Art

There is known a liquid-crystal display device with a built-in elliptically polarizing plate that comprises an optically compensatory film. The viewing angle characteristic of such a liquid-crystal display device may worsen mainly owing to the light leakage at the time of black level of display. It is known that the light leakage at the time of black level of display is caused by the strain of an optically compensatory film to occur depending on the ambient temperature and humidity; and a fact is disclosed that, when a film having little dimensional change in a wet heat environment is used, then a problem of light leakage at the time of black level of a liquid-crystal display device can be solved and the viewing angle characteristic of the display can be thereby improved (for example, see JP-A 2004-151640 and JP-A 2002-179819). Further, JP-A 2004-151640 discloses a retardation film stretched so as to have little dimensional change in a wet heat environment and to express a retardation falling within a specific range.

For producing a film having little dimensional change in a wet heat environment, JP-A 2004-151640 discloses a method of stretching a film formed by solution casting, under a specific condition, precisely, a method of controlling the temperature in stretching and controlling the residual solvent amount in the stretched film. On the other hand, JP-A 2002-179819 discloses a method of wet heat treatment of a film formed by solution casting.

However, even a liquid-crystal display device comprising such an optically compensatory film is not still on a satisfactory level in point of the viewing angle characteristic thereof, and it is desired to further improve the viewing angle characteristic of the display device.

In that way, solving the problem of dimensional change in an optically compensatory film under a wet heat condition has been heretofore much discussed, as in JP-A 2004-151640 and JP-A 2002-179819; however, nothing has heretofore been analyzed and investigated about the detailed reasons of light leakage at the time of black level of a liquid-crystal display device. Specifically, the conventional tendency in the art toward development of an optically compensatory film capable of improving the viewing angle characteristic of a liquid-crystal display device is to reduce as much as possible the light leakage at the time of black level of display of a liquid-crystal display device, or that is, to make the light leakage near to zero.

### SUMMARY OF THE INVENTION

The present inventors have analyzed and investigated the detailed reasons of light leakage at the time of black level of display for the purpose of improving the viewing angle characteristic of a liquid-crystal display device. As a result, the inventors have found that, when light leakage has occurred at the time of black level of display, the black color expression has changed in the liquid-crystal display device, and the black color expression change will facilitate and augment the recognition of light leakage at the time of black level of display. Accordingly, the inventors have intended to obtain an improved film not only capable of reducing the light leakage at the time of black level of a liquid-crystal display device but also capable of reducing the black color expression change even in occurrence of light leakage therefore retarding the recognition of light leakage.

Specifically, an object of the invention is to provide a film of which, the dimensional change (strain) under a wet heat condition is reduced and of which the black color expression change when incorporated in a liquid-crystal display device is also reduced.

The inventors have assiduously studied for the purpose of solving the above-mentioned problems and, as a result, have found that, when a film having reversed wavelength dispersion characteristics of retardation is incorporated in a liquid-crystal display device, then surprisingly the black color expression change in the display device is reduced. Specifically, the inventors have found that a cellulose acylate film mentioned below, which has little dimensional change under a wet heat condition and which has reversed wavelength dispersion characteristics of retardation, can solve the above-mentioned problems, and have found that the cellulose acylate film having the characteristics can be produced under a specific stretching condition mentioned below and under a specific wet heat treatment condition also mentioned below. On the basis of these findings, the inventors have completed the present invention. In JP-A 2004-151640 and JP-A 2002-179819, nothing is referred to at all relating to improving the characteristics of color expression change of the optically compensatory film itself.

[1] A cellulose acylate film of which the difference between the in-plane retardation at a wavelength of 630 nm and the in-plane retardation at a wavelength of 450 nm, ΔRe satisfies the following formula (1), and of which the dimensional change before and after a lapse of time of 24 hours at 60° C. and 90% RH satisfies the following formula (2) both in the film traveling direction and in the direction perpendicular thereto:

1 nm≦ΔRe≦15 nm (1)

−0.5%≦{(L′−L0)/L0}×100≦0.5% (2),

in formula (2), L0 means the length of the film (unit, mm) before the lapse of time of 24 hours at 60° C. and 90% RH; and L′ means the length of the film (unit, mm) after the lapse of time of 24 hours at 60° C. and 90% RH followed by humidity conditioning for 2 hours.

[2] The cellulose acylate film of [1], of which the in-plane retardation Re at a wavelength of 590 nm satisfies the following formula (3), and of which the thickness-direction retardation Rth at a wavelength of 590 nm satisfies the following formula (4):

30 nm≦Re≦70 nm (3)

90 nm≦Rth≦300 nm (4)

Rth=((nx+ny)/2−nz)×d (4′),

in formula (4′), nx, ny and nz each mean the refractive index of an index ellipsoid in the respective main axial directions, and d means the thickness of the film.

[3] The cellulose acylate film of [1] or [2], wherein the degree of acyl substitution of the cellulose acylate in the cellulose acylate film satisfies the following formulae (5) and (6):

2.3≦A+B≦2.6 (5)

0≦B≦1 (6),

in formulae (5) and (6), A means the degree of substitution with an acetyl group in the cellulose acylate; and B means the degree of substitution with a propionyl group or a butyryl group in the cellulose acylate.

[4] The cellulose acylate film of any one of [1] to [3], which has a two-layered or more multilayered structure.

[5] The cellulose acylate film of [4], wherein the total degree of acyl substitution DSa in the layer of a cellulose acylate having the highest total degree of acyl substitution, and the total degree of acyl substitution DSb in the layer of a cellulose acylate having the lowest total degree of acyl substitution satisfy the following formula (7):

0.1≦DSa−DSb≦0.5 (7).

[6] A method for producing a cellulose acylate film, which comprises stretching a cellulose acylate film at a temperature satisfying the following formula (8), followed by processing the stretched film for wet heat treatment under a condition satisfying the following formulae (9) and (10):

Te−30° C.≦(stretching temperature)≦Te+30° C. (8)

Te=T[tan δ]−ΔTm (8′)

ΔTm=Tm(0)−Tm(x) (8″),

in formula (8), T[tan δ] means a temperature at which tan δ shows a peak, and tan δ means the dynamic viscoelasticity of the cellulose acylate in which the residual solvent amount is 0%; Tm(0) means the crystal melting temperature of the cellulose acylate in which the residual solvent amount is 0%; Tm(x) means the crystal melting temperature of the cellulose acylate in which the residual solvent amount is x %,

60° C.≦(wet heat treatment temperature)≦130° C. (9)

200 g/m³≦(absolute humidity in wet heat treatment)≦500 g/m³ (10).

[7] The method for producing a cellulose acylate film of [6], which comprises stretching a cellulose acylate film that satisfies the following formulae (5) and (11) at a temperature satisfying the following formula (12), followed by processing the stretched film for wet heat treatment under the condition satisfying the following formulae (13) and (14):

2.3≦A+B≦2.6 (5)

B=0 (11),

in formulae (5) and (11), A means the degree of substitution with an acetyl group in the cellulose acylate; and B means the degree of substitution with a propionyl group or a butyryl group in the cellulose acylate,

Te−20° C.≦(stretching temperature)≦Te+20° C. (12)

Te=T[tan δ]−ΔTm (12′)

ΔTm=Tm(0)−Tm(x) (12″),

in formula (12), T[tan δ] means a temperature at which tan δ shows a peak, and tan δ means the dynamic viscoelasticity of the cellulose acylate in which the residual solvent amount is 0%; Tm(0) means the crystal melting temperature of the cellulose acylate in which the residual solvent amount is 0%; Tm(x) means the crystal melting temperature of the cellulose acylate in which the residual solvent amount is x %,

70° C.≦(wet heat treatment temperature)≦120° C. (13)

250 g/m³≦(absolute humidity in wet heat treatment)≦400 g/m³ (14).

[8] A cellulose acylate film produced according to the cellulose acylate production method of [6] or [7].

[9] A retardation film comprising at least one cellulose acylate film of any one of [1] to [5] and [8].

[10] A polarizer comprising at least one of the cellulose acylate film of any one of [1] to [5] and [8], or the retardation film of [9].

[11] A liquid-crystal display device comprising at least one of the cellulose acylate film of any one of [1] to [5] and [8], the retardation film of [9], or the polarizer of [10].

According to the production method of the invention, the cellulose acylate film of the invention can be obtained which has little dimensional change under a wet heat condition and which has reversed wavelength dispersion characteristics of retardation. When the cellulose acylate film of the invention is incorporated in a liquid-crystal display device, the light leakage at the time of black level of display can be reduced and, at the same time, the black color expression change that may occur in light leakage at the time of black level of display can be reduced, and therefore, in the display device, the light leakage, if occurring at the time of black level of display, is hardly recognized. Accordingly, use of the cellulose acylate film of the invention has the advantage in that the viewing angle-related visibility of the liquid-crystal display device in which the cellulose acylate film is incorporated can be significantly improved. The film and the polarizer comprising the film of the invention are favorably used in a liquid-crystal display device, especially favorably in a VA-mode liquid-crystal display device.

### BRIEF DESCRIPTION OF THE DRAWING

FIG. 1 is a schematic cross-sectional view of one example of the liquid-crystal display device of the invention. 11 denotes polarizing element, 12 denotes polarizing element, 13 denotes liquid-crystal cell, 14 denotes cellulose acylate film of Examples or Comparative Examples, and 15 denotes Fujitac TD80UL.

### BEST MODE FOR CARRYING OUT THE INVENTION

The cellulose acylate film and its production method of the invention, and additives thereto are described in detail hereinunder.

The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. In the description, MD means the machine direction, or that is, the film traveling direction; and TD means the transverse direction, or that is the direction perpendicular to MD. A film of which the in-plane retardation at a wavelength of 630 nm is larger than the in-plane retardation at a wavelength of 450 nm is referred to as a reversed dispersion film, or a film having reversed wavelength dispersion characteristics of retardation.

### [Cellulose Acylate Film]

The cellulose acylate film of the invention (hereinafter this may be referred to as the film of the invention) is such that the difference between the in-plane retardation thereof at a wavelength of 630 nm and the in-plane retardation thereof at a wavelength of 450 nm, ΔRe satisfies the following formula (1), and the dimensional change thereof before and after a lapse of time of 24 hours at 60° C. and 90% RH satisfies the following formula (2) both in MD and in TD:

1 nm≦ΔRe≦15 nm (1)

−0.5%{(L′−L0)/L0}×100≦0.5% (2),

in formula (2), L0 means the length of the film (unit, mm) before the lapse of time of 24 hours at 60° C. and 90% RH; and L′ means the length of the film (unit, mm) after the lapse of time of 24 hours at 60° C. and 90% RH followed by humidity conditioning for 2 hours.

The invention is described concretely hereinunder with reference to preferred embodiments of the film of the invention.

### (Cellulose Acylate)

In the cellulose acylate for use in the invention, the degree of substitution with an acyl group is not specifically defined. The starting material cellulose for the acylate includes cotton linter and wood pulp (broad-leaved tree pulp, coniferous tree pulp), etc.; and any cellulose acylate obtained from any starting material cellulose is employable herein. As the case may be, mixtures of cellulose acylates are also usable. The details of the starting material cellulose are described, for example, in Marusawa & Uda's “Plastic Materials Lecture (17), Cellulose Resins” by Nikkan Kogyo Shinbun (1970) and in Hatsumei Kyokai Disclosure Bulletin No. 2001-1745 (pp. 7 and 8).

One type alone or two or more different types of acyl groups may be in the film of the invention. Preferably, the film of the invention has an acyl group with from 2 to 4 carbon atoms as the substituent. In case where the film has two or more different types of acyl groups, one of them is preferably an acetyl group, and as the acyl group having from 2 to 4 carbon atoms, preferred is a propionyl group or a butyryl group. A dope of good solubility for the film can be produced, and especially in a chlorine-free organic solvent, a good dope can be produced. In addition, a dope having a low viscosity and having good filterability can be produced.

### (Cellulose Acylate)

The cellulose acylate preferred for use in the invention is described in detail. The glucose units with β-1,4 bonding to each other to constitute cellulose have a free hydroxyl group at the 2-, 3- and 6-positions thereof. Cellulose acylate is a polymer derived from it through partial or complete esterification of those hydroxyl groups therein. The degree of acyl substitution as referred to herein means the total ratio of acylation of the 2-, 3- and 6-positioned hydroxyl groups in cellulose (100% acylation at each position is represented by a degree of substitution of 1).

The acyl group having 2 or more carbon atoms in the cellulose used in the invention may be an aliphatic group or an aryl group, and are not particularly limited. They may be an alkylcarbonyl ester of cellulose, an alkenylcarbonyl ester of cellulose, an aromatic carbonyl ester of cellulose or an aromatic alkylcarbonyl ester of cellulose. These esters may have a substituent. Preferable examples of the substituents include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. An acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and an acetyl group, a propionyl group and a butanoyl group (in case where the acyl group has from 2 to 4 carbon atoms) are particularly preferred, and the most preferred is an acetyl group (in case where the cellulose acylate is a cellulose acetate).

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

Preferably, the degree of acyl substitution in the cellulose acylate to form the film of the invention satisfies the following formulae (5) and (6):

2.3 ≦A+B≦2.6 (5)

0≦B≦1 (6),

in formulae (5) and (6), A means the degree of substitution with an acetyl group in the cellulose acylate; and B means the degree of substitution with a propionyl group or a butyryl group in the cellulose acylate.

When (A+B) is at most 2.6, then the optical expressibility of the film may be bettered favorably; and when (A+B) is at least 2.3, then the dimensional change thereof can be reduced also favorably. When B is at most 1, then the optical expressibility of the film may be bettered favorably.

More preferably, the degree of acyl substitution in the cellulose acylate to form the film of the invention satisfies the following formulae (5′) and (6′):

2.35≦A+B≦2.55 (5′)

0≦B≦0.7 (6′).

Even more preferably, the degree of acyl substitution in the cellulose acylate to form the film of the invention satisfies the following formulae (5″) and (6″):

2.4≦A+B≦2.5 (5″)

B=0 (6″).

In the preferred embodiments of the invention, even when the cellulose acylate film comprises a cellulose acylate having a low degree of acyl substitution, the dimensional change thereof under a wet heat condition may be reduced, and at the same time, the wavelength dispersion characteristics of the film can be improved, and therefore, a cellulose acylate film comprising such a cellulose acylate having a low degree of acyl substitution can be well produced. Such a cellulose acylate film comprising a cellulose acylate having a low degree of acyl substitution could not be produced satisfactorily under conventional production conditions, since the dimensional change of the film under a wet heat condition is great.

The cellulose acylate for use in the invention can be produced, for example, according to the method described in JP-A 10-45804.

### (Layer Constitution of Cellulose Acylate Film)

The film of the invention may have a single-layer or a two-layer more multilayer structure so far as it satisfies the conditions of the above-mentioned formulae (1) and (2). In the multilayer structure, the degree of acyl substitution in the cellulose acylate in the individual layers may be the same; or different types of cellulose acylate may form one layer as combined. Preferably, the degree of acyl substituted in the cellulose acylate in the individual layers is the same from the viewpoint of regulating the optical properties of the film.

In case where the film of the invention has a single layer structure, the degree of acyl substitution in the cellulose acylate to constitute the film preferably satisfies the above formulae (5) and (6), more preferably the above formulae (5′) and (6′), even more preferably the above formulae (5″) and (6″).

In more preferred embodiments of the invention, there is provided a cellulose acylate laminate film that has little dimensional change under a wet heat condition and has reversed wavelength dispersion characteristics of retardation, which, however, could not be realized by conventional cellulose acylate films. In addition, in film formation by solution casting, the formed film can be readily peeled from the support.

Preferably, the film of the invention has a two-layer or more multilayer laminate structure from the viewpoint of improving the releasability of the film from the support in formation it by solution casting.

In case where the film of the invention has a two-layer or more multilayer laminate structure, preferably, at least one layer therein contains a cellulose acylate satisfying the above formulae (5) and (6) and at least another layer except the layer that contains a cellulose acylate satisfying the above formulae (5) and (6) contains a cellulose acylate satisfying the following formula (15), from the viewpoint of improving the releasability of the film from the support in formation it by solution casting.

2.6<A+B<3.0 (15),

in formula (15), DS means the degree of acyl substitution in the cellulose acylate.

In this description, the layer in which the cellulose acylate completely satisfies the above formulae (5) and (6) may be referred to as a low-substitution layer; and the layer in which the cellulose acylate completely satisfies the above formula (15) may be referred to as a high-substitution layer.

More preferably, the cellulose acylate in the high-substitution layer satisfies the following formula (15′), even more preferably the following formula (15″).

2.7≦A+B≦2.9 (15′)

2.75≦A+B≦2.85 (15″).

Preferably, the film of the invention has a two-layer or more multilayer laminate structure, in which the layer to be in contact with the support in film formation by solution casting (hereinafter this may be referred to as a skin B layer or an SB layer) contains a cellulose acylate satisfying the above formula (15) and the other layers contain a cellulose acylate satisfying the above formulae (5) and (6), from the viewpoint of improving more the releasability of the formed film from the support in solution casting. More preferably, the film of the invention has a two-layer or more multilayer laminate structure, in which the skin B layer is a high-substitution layer and the other layers are low-substitution layers, from the viewpoint of still more improving the releasability of the formed film from the support in solution casting.

In case where the film of the invention has a two-layer structure, preferably, the skin B layer of the film is a high-substitution layer and the other layer is a low-substitution layer. The more preferred range of each layer is the same as the above-mentioned preferred range. In case where the film of the invention has a two-layer structure, the other layer than the skin B layer (that is, the surface layer) may be referred to as a core layer for convenience sake; however, the core layer in this differs from the core layer (internal layer) of the film of the invention having a three-layer or more multilayer structure to be mentioned below.

In more preferred embodiments of the invention, the film has a high-substitution cellulose acylate layer on both sides of a low-substitution cellulose acylate layer, and the film of the type can have well controlled physical properties (curling resistance). Preferably, the film of the invention has a three-layer or more multilayer laminate structure from the viewpoint of reducing the degree of curling of the film in environmental wet heat change.

Preferably, the film of the invention has a three-layer or more multilayer laminate structure in which at least one inner layer (hereinafter this may be referred to as a core layer or a C layer) contains a cellulose acylate satisfying the above formulae (5) and (6) and the surface layer on both sides thereof contains a cellulose acylate satisfying the above formula (15) from the viewpoint of increasing the latitude in the process of realizing the desired optical properties thereof as an optically compensatory film. More preferably, the film of the invention has a three-layer or more multilayer laminate structure, in which the cellulose acylate in at least one inner layer completely satisfies the above formulae (5) and (6) and the cellulose acylate in the surface layer on both sides completely satisfies the above formula (15). In case where the film of the invention has a three-layer or more multilayer structure, the surface layer thereof on the side not in contact with the support in film formation is referred to as a skin A layer or an SA layer.

Preferably, the film of the invention has a three-layer structure. Specifically, the film of the invention preferably has a three-layer structure of skin B layer/core layer/skin A layer. In case where the film of the invention has a three-layer structure, it may have a constitution of high-substitution layer/low-substitution layer/high-substitution layer, or a constitution of low-substitution layer/high-substitution layer/low-substitution layer; however, preferred is a constitution of high-substitution layer/low-substitution layer/high-substitution layer from the viewpoint of improving the releasability of the film from the support in forming it by solution casting and from the viewpoint of reducing the degree of curling of the film in environmental wet heat change.

In case where the film of the invention has a three-layer structure, preferably, the cellulose acylate constituting the surface layer on both sides has the same degree of acyl substitution from the viewpoint of reducing the production cost and reducing the degree of curling of the film in environmental wet heat change.

In the film of the invention, preferably the total degree of acyl substitution DSa in the layer of a cellulose acylate having a highest total degree of acyl substitution, and the total degree of acyl substitution DSb in the layer of a cellulose acylate having a lowest total degree of acyl substitution satisfy the following formula (7):

0.1≦DSa−DSb≦0.5 (7).

When the value of DSa−DSb is at most 0.5, then the film releasability is good, and the compatibility between the constitutive layers may be bettered and therefore the film may be prevented from being whitened. When the value of DSa−DSb is at least 0.1, then the compatibility between the constitutive layers may be bettered and the releasability of the film may also be bettered.

Having either a laminate structure or a single layer structure, the film of the invention preferably has a thickness of from 20 to 130 μm as a whole, more preferably from 25 to 100 μm, even more preferably from 40 to 80 μm.

In case where the film of the invention has a two-layer or more multilayer laminate structure, the low-substitution layer (preferably the other layer than the skin B layer) therein preferably has a thickness of from 15 to 125 μm, more preferably from 20 to 95 μm, even more preferably from 35 to 75 μm.

In case where the film of the invention has a three-layer or more multilayer laminate structure, the low-substitution layer (preferably the core layer) preferably has a thickness of from 15 to 125 μm, more preferably from 20 to 95 μm, even more preferably from 35 to 75 μm.

In case where the film of the invention has a three-layer or more multilayer laminate structure, the surface layer on both sides of the film preferably has a thickness of from 0.2 to 10 μm, more preferably from 0.5 to 5 μm, even more preferably from 1 to 4 μm.

In one preferred embodiment of the invention, the film has a three-layer or more multilayer laminate structure, in which at least one inner layer (core layer) is a low-substitution layer, and the surface layers (skin B layer and skin A layer) each are a high-substitution layer. Preferably, the thickness of the surface layers (skin B layer and skin A layer) is smaller than the thickness of the inner layer. Preferred conditions of the thickness of the surface layer are as mentioned above.

A more preferred embodiment of the film of the invention has a three-layer laminate structure, in which the inner layer (core layer) is a low-substitution layer and the surface layers (skin B layer and skin A layer) each are a high-substitution layer. More preferably, the thickness of the skin B layer and the skin A layer is smaller than the thickness of the core layer. The preferred conditions of the thickness of the surface layers are the same as those in the film of the invention having the three-layer or more multilayer laminate structure.

### (ΔRe)

The film of the invention is a reversed dispersion film of which the difference between the in-plane retardation at a wavelength of 630 nm Re(630), and the in-plane retardation at a wavelength of 450 nm Re(450), ΔRe (or that is, ΔRe=Re(630)−Re(450)) satisfies the following formula (1):

1 nm≦ΔRe≦15 nm (1)

When ΔRe falls within the range of formula (1), then the black color expressibility of the film can be significantly enhanced. More preferably, ΔRe is from 1 to 14 nm, even more preferably from 1.5 to 13 nm.

### (Dimensional Change)

Of the film of the invention, the dimensional change before and after a lapse of time of 24 hours at 60° C. and 90% RH satisfies the following formula (2) both in the film traveling direction and in the direction perpendicular thereto:

−0.5%≦{(L′−L0)/L0}×100≦0.5% (2)

In the formula, L0 means the length of the film before the lapse of time of 24 hours at 60° C. and 90% RH; and L′ means the length of the film after the lapse of time of 24 hours at 60° C. and 90% RH followed by humidity conditioning for 2 hours.

When the dimensional change falls within the range of formula (2), then the film can prevent the light leakage at the time of black level of display when incorporated into a liquid-crystal display device. More preferably, the dimensional change is from −0.4 to 0.4%, even more preferably from −0.3 to 0.3%.

### (Re, Rth)

Of the film of the invention, preferably, the in-plane retardation Re at a wavelength of 590 nm satisfies the following formula (3) and the thickness-direction retardation Rth at a wavelength of 590 nm satisfies the following formula (4), from the viewpoint of using the film as a retardation film for optical compensation in a liquid-crystal display device.

30 nm≦Re≦70 nm (3)

90 nm≦Rth≦300 nm (4)

Rth=((nx+ny)/2−nz)×d (4′).

In formula (4′), nx, ny and nz each mean the refractive index of an index ellipsoid in the respective main axial directions, and d means the thickness of the film.

Re is more preferably from 35 to 65 nm, even more preferably from 40 to 60 nm.

Rth is more preferably from 95 to 250 nm, even more preferably from 100 to 210 nm.

Re(λ) and Rth(λ) represent, herein, the retardation in the plane and the retardation in the thickness direction, respectively, at a wavelength of λ. In the specification, λ is a wavelength of 590 nm unless otherwise noted. Re(λ) is measured with KOBRA 21ADH or WR (by Oji Scientific Instruments) while allowing light having the wavelength of λ nm to enter in the normal direction of a film. With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample. With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (A) and (B). The mean refractive index may be used values described in catalogs for various types of optical films. When the mean refractive index has not known, it may be measured with Abbe refractometer. The mean refractive index for major optical film is described below: cellulose acylate (1.48), cycloolefin polymer (1.52), polycarbonate (1.59), polymethylmethacrylate (1.49), polystyrene (1.59). By inputting the value of these average refraction indices and thickness, KOBRA 21ADH or WR computes nx, ny, nz. From the computed nx, ny, nz, Nz=(nx−nz)/(nx−ny) is computed further.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad ( A )$$

The above Re(θ) represents the retardation in a direction that inclines in the degree of θ from the normal direction; and d is a thickness of the film.

Rth={(nx+ny)/2−nz}×d (B)

In this, the mean refractive index n is needed as a parameter, and it is measured with an Abbe refractiometer (Atago's Abbe Refractiometer 2-T).

### <Additives>

In the invention, widely employable are various high-molecular-weight additives and low-molecular-weight additives known as additives for cellulose acylate films. The amount of the additive is preferably from 1 to 35% by mass, more preferably from 4 to 30% by mass, even more preferably from 10 to 25% by mass relative to the cellulose resin. When the amount of the additive is less than 1% by mass, then it could not follow the ambient temperature/humidity change; and when more than 30% by mass, then the film may be whitened, and in addition, the physical properties of the film may worsen.

The additives in the invention are ingredients to be added to the optical film of the invention for the purpose of enhancing the functions of the film, which are added in an amount of at least 1% by mass relative to the cellulose resin. Accordingly, impurities and residual solvent and the like are not the additives in the invention.

In the invention, preferably, the content of the high-molecular-weight additive is from 4 to 30% by mass, more preferably from 10 to 25% by mass relative to the cellulose resin.

In the invention, two or more different types of additives may be used as combined. Using two or more different types of additives as combined brings about the advantage of satisfying the effects of enhancing the optical properties, increasing the film elasticity, reducing the film brittleness and enhancing the web handlability.

### (High-Molecular-Weight Additive)

The high-molecular-weight additive to be added to the film of the invention is preferably a compound having recurring units in the molecule thereof and having a number-average molecular weight of from 700 to 10000. The high-molecular-weight additive is used in a solution casting method for accelerating the evaporation speed of a solvent and for reducing the residual solvent amount in the formed film. Also in the film to be formed according to a melt casting method, the high-molecular-weight additive is effective for preventing the formed film from being colored or for preventing the strength of the formed film from being lowered. Adding such a high-molecular-weight additive to the film of the invention is effective for enhancing the mechanical properties of the film and for reforming the film by making the film soft, or by making the film resistant to water absorption, or by reducing the moisture permeability through the film.

The number-average molecular weight of the high-molecular-weight additive in the invention is preferably from 700 to less than 10000, more preferably from 800 to 8000, even more preferably from 800 to 5000, still more preferably from 1000 to 5000. Falling within the range, the additive may have more excellent compatibility with the cellulose resin.

The high-molecular-weight additive for use in the invention is described in detail hereinunder with reference to specific examples thereof. Needless-to-say, the high-molecular-weight additive for use in the invention is not limited to these examples.

Not specifically defined, the high-molecular-weight additive is preferably a polyester-type polymer, more preferably an aliphatic polyester and an aromatic polyester.

### Polyester-Type Polymer:

The polyester-type polymer for use in the invention is one to be produced through reaction of a mixture of an aliphatic dicarboxylic acid having from 2 to 20 carbon atoms and an aromatic dicarboxylic acid having from 8 to 20 carbon atoms, with at least one diol selected from an aliphatic diol having from 2 to 12 carbon atoms, an alkyl ether diol having from 4 to 20 carbon atoms and an aromatic diol having from 6 to 20 carbon atoms, and the two ends of the reaction product may be left as those in the reaction product or may be further reacted with a monocarboxylic acid, a monoalcohol or a phenol whereby the terminals may be blocked. The terminal blocking is preferably attained in order that the resulting polymer does not have a free carboxylic acid terminal, and this is effective for enhancing the storage stability of the polymer. Preferably, the dicarboxylic acid for use in the polyester-type polymer in the invention is an aliphatic dicarboxylic acid residue having from 4 to 20 carbon atoms or an aromatic dicarboxylic acid residue having from 8 to 20 carbon atoms.

The aliphatic dicarboxylic acids having from 2 to 20 carbon atoms preferably for use in the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid, etc.

Of those aliphatic dicarboxylic acids, preferred are malonic acid, succinic acid, maleic acid, fumaric acid, glutaric acid, adipic acid, azelaic acid, and 1,4-cyclohexanedicarboxylic acid; and of those aromatic dicarboxylic acids, preferred are phthalic acid, terephthalic acid, isophthalic acid, 1,5-naphthalenedicarboxylic acid, and 1,4-naphthalenedicarboxylic acid. More preferably, the aliphatic dicarboxylic acid ingredient includes succinic acid, glutaric acid and adipic acid; and the aromatic dicarboxylic acid includes phthalic acid, terephthalic acid and isophthalic acid.

In the invention, at least one of the above-mentioned aliphatic dicarboxylic acids and at least one of the above-mentioned aromatic dicarboxylic acids is combined, and the combination is not specifically defined. Some of the respective ingredients may be combined with no problem.

The diol or the aromatic ring-containing diol for use in the high-molecular weight additive is, for example, selected from an aliphatic diol having from 2 to 20 carbon atoms, an alkyl ether dial having from 4 to 20 carbon atoms, and an aromatic ring-containing diol having from 6 to 20 carbon atoms.

Examples of the aliphatic diol having from 2 to 20 carbon atoms include an alkyldiol and an aliphatic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol (3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic diols include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether diols having from 4 to 20 carbon atoms are polytetramethylene ether glycol, polyethylene ether glycol and polypropylene ether glycol, and combinations of these. The average degree of polymerization is not limited in particular, and it is preferably from 2 to 20, more preferably 2 to 10, further preferably from 2 to 5, especially preferably from 2 to 4. As these examples, Carbowax resin, Pluronics resin and Niax resin are commercially available as typically useful polyether glycols.

Not specifically defined, the aromatic diol having from 6 to 20 carbon atoms includes bisphenol A, 1,2-hydroxybenzene, 1,3-hydroxybenzene, 1,4-hydroxybenzene, 1,4-benzenedimethanol; and preferred are bisphenol A, 1,4-hydroxybenzene, and 1,4-benzenedimethanol.

In the invention, especially preferred is a high-molecular additive of which the terminal is blocked with an alkyl group or an aromatic group. The terminal protection with a hydrophobic functional group is effective against aging at high temperature and high humidity, by which the hydrolysis of the ester group is retarded.

Preferably, the polyester plasticizer in the invention is protected with a monoalcohol residue or a monocarboxylic acid residue in order that both ends of the polyester plasticizer are not a carboxylic acid or a hydroxyl group.

In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It maybe an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

The high-molecular additive for use in the invention may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The polyester additives are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

Specific examples of the polyester-type polymer usable in the invention are shown below; however, the polyester-type polymer for use in the invention should not be limited to these.

TABLE 1

| | Dicarboxylic Acid | | | Diol | | | Number |
|---|---|---|---|---|---|---|---|
| | Aromatic | Aliphatic | Ratio of | | Ratio | | Average |
| | Dicarboxylic | Dicarboxylic | Dicarboxylic | Aliphatic | of Diol | | Molecular |
| | Acid | Acid | Acid (mol %) | Diol | (mol %) | Terminal | Weight |
| P-1 | — | AA | 100 | ethane diol | 100 | hydroxyl group | 1000 |
| P-2 | — | AA | 100 | ethane diol | 100 | hydroxyl group | 2000 |
| P-3 | — | AA | 100 | propane diol | 100 | hydroxyl group | 2000 |
| P-4 | — | AA | 100 | butane diol | 100 | hydroxyl group | 2000 |
| P-5 | — | AA | 100 | hexane diol | 100 | hydroxyl group | 2000 |
| P-6 | — | AA/SA | 60/40 | ethane diol | 100 | hydroxyl group | 900 |
| P-7 | — | AA/SA | 60/40 | ethane diol | 100 | hydroxyl group | 1500 |
| P-8 | — | AA/SA | 60/40 | ethane diol | 100 | hydroxyl group | 1800 |
| P-9 | — | SA | 100 | ethane diol | 100 | hydroxyl group | 1500 |
| P-10 | — | SA | 100 | ethane diol | 100 | hydroxyl group | 2300 |
| P-11 | — | SA | 100 | ethane diol | 100 | hydroxyl group | 6000 |
| P-12 | — | SA | 100 | ethane diol | 100 | hydroxyl group | 1000 |
| P-13 | PA | SA | 50/50 | ethane diol | 100 | hydroxyl group | 1000 |
| P-14 | PA | SA | 50/50 | ethane diol | 100 | hydroxyl group | 1800 |
| P-15 | PA | AA | 50/50 | ethane diol | 100 | hydroxyl group | 2300 |
| P-16 | PA | SA/AA | 40/30/30 | ethane diol | 100 | hydroxyl group | 1000 |
| P-17 | PA | SA/AA | 50/20/30 | ethane diol | 100 | hydroxyl group | 1500 |
| P-18 | PA | SA/AA | 50/30/20 | ethane diol | 100 | hydroxyl group | 2600 |
| P-19 | TPA | SA | 50/50 | ethane diol | 100 | hydroxyl group | 1000 |
| P-20 | TPA | SA | 50/50 | ethane diol | 100 | hydroxyl group | 1200 |
| P-21 | TPA | AA | 50/50 | ethane diol | 100 | hydroxyl group | 2100 |
| P-22 | TPA | SA/AA | 40/30/30 | ethane diol | 100 | hydroxyl group | 1000 |
| P-23 | TPA | SA/AA | 50/20/30 | ethane diol | 100 | hydroxyl group | 1500 |
| P-24 | TPA | SA/AA | 50/30/20 | ethane diol | 100 | hydroxyl group | 2100 |
| P-25 | PA/TPA | AA | 15/35/50 | ethane diol | 100 | hydroxyl group | 1000 |
| P-26 | PA/TPA | AA | 20/30/50 | ethane diol | 100 | hydroxyl group | 1000 |
| P-27 | PA/TPA | SA/AA | 15/35/20/30 | ethane diol | 100 | hydroxyl group | 1000 |
| P-28 | PA/TPA | SA/AA | 20/30/20/30 | ethane diol | 100 | hydroxyl group | 1000 |
| P-29 | PA/TPA | SA/AA | 10/50/30/10 | ethane diol | 100 | hydroxyl group | 1000 |
| P-30 | PA/TPA | SA/AA | 5/45/30/20 | ethane diol | 100 | hydroxyl group | 1000 |
| P-31 | — | AA | 100 | ethane diol | 100 | acetyl ester residue | 1000 |
| P-32 | — | AA | 100 | ethane diol | 100 | acetyl ester residue | 2000 |
| P-33 | — | AA | 100 | propane diol | 100 | acetyl ester residue | 2000 |
| P-34 | — | AA | 100 | butane diol | 100 | acetyl ester residue | 2000 |
| P-35 | — | AA | 100 | hexane diol | 100 | acetyl ester residue | 2000 |
| P-36 | — | AA/SA | 60/40 | ethane diol | 100 | acetyl ester residue | 900 |

TABLE 2

| | Dicarboxylic Acid | | | Diol | | | Number |
|---|---|---|---|---|---|---|---|
| | Aromatic | Aliphatic | Ratio of | | Ratio | | Average |
| | Dicarboxylic | Dicarboxylic | Dicarboxylic | Aliphatic | of Diol | | Molecular |
| | Acid | Acid | Acid (mol %) | Diol | (mol %) | Terminal | Weight |
| P-37 | — | AA/SA | 60/40 | ethane diol | 100 | acetyl ester residue | 1000 |
| P-38 | — | AA/SA | 60/40 | ethane diol | 100 | acetyl ester residue | 2000 |
| P-39 | — | SA | 100 | ethane diol | 100 | acetyl ester residue | 1000 |
| P-40 | — | SA | 100 | ethane diol | 100 | acetyl ester residue | 3000 |
| P-41 | — | SA | 100 | ethane diol | 100 | acetyl ester residue | 5500 |
| P-42 | — | SA | 100 | ethane diol | 100 | acetyl ester residue | 1000 |
| P-43 | PA | SA | 50/50 | ethane diol | 100 | acetyl ester residue | 1000 |
| P-44 | PA | SA | 50/50 | ethane diol | 100 | acetyl ester residue | 1500 |
| P-45 | PA | AA | 50/50 | ethane diol | 100 | acetyl ester residue | 2000 |
| P-46 | PA | SA/AA | 40/30/30 | ethane diol | 100 | acetyl ester residue | 1000 |
| P-47 | PA | SA/AA | 33/33/34 | ethane diol | 100 | benzoic acid | 1000 |
| P-48 | PA | SA/AA | 50/20/30 | ethane diol | 100 | acetyl ester residue | 1500 |
| P-49 | PA | SA/AA | 50/30/20 | ethane diol | 100 | acetyl ester residue | 2000 |
| P-50 | TPA | SA | 50/50 | ethane diol | 100 | acetyl ester residue | 1000 |
| P-51 | TPA | SA | 50/50 | ethane diol | 100 | acetyl ester residue | 1500 |
| P-52 | TPA | SA | 45/55 | ethane diol | 100 | acetyl ester residue | 1000 |
| P-53 | TPA | AA | 50/50 | ethane diol | 100 | acetyl ester residue | 2200 |
| P-54 | TPA | SA | 35/65 | ethane diol | 100 | acetyl ester residue | 1000 |
| P-55 | TPA | SA/AA | 40/30/30 | ethane diol | 100 | acetyl ester residue | 1000 |
| P-56 | TPA | SA/AA | 50/20/30 | ethane diol | 100 | acetyl ester residue | 1500 |
| P-57 | TPA | SA/AA | 50/30/20 | ethane diol | 100 | acetyl ester residue | 2000 |
| P-58 | TPA | SA/AA | 20/20/60 | ethane diol | 100 | acetyl ester residue | 1000 |
| P-59 | PA/TPA | AA | 15/35/50 | ethane diol | 100 | acetyl ester residue | 1000 |
| P-60 | PA/TPA | AA | 25/25/50 | ethane diol | 100 | acetyl ester residue | 1000 |
| P-61 | PA/TPA | SA/AA | 15/35/20/30 | ethane diol | 100 | acetyl ester residue | 1000 |
| P-62 | PA/TPA | SA/AA | 20/30/20/30 | ethane diol | 100 | acetyl ester residue | 1000 |
| P-63 | PA/TPA | SA/AA | 10/50/30/10 | ethane diol | 100 | acetyl ester residue | 1000 |
| P-64 | PA/TPA | SA/AA | 5/45/30/20 | ethane diol | 100 | acetyl ester residue | 1000 |
| P-65 | PA/TPA | SA/AA | 5/45/20/30 | ethane diol | 100 | acetyl ester residue | 1000 |
| P-66 | IPA | AA/SA | 20/40/40 | ethane diol | 100 | acetyl ester residue | 1000 |
| P-67 | 2,6-NPA | AA/SA | 20/40/40 | ethane diol | 100 | acetyl ester residue | 1200 |
| P-68 | 1,5-NPA | AA/SA | 20/40/40 | ethane diol | 100 | acetyl ester residue | 1200 |
| P-69 | 1,4-NPA | AA/SA | 20/40/40 | ethane diol | 100 | acetyl ester residue | 1200 |
| P-70 | 1,8-NPA | AA/SA | 20/40/40 | ethane diol | 100 | acetyl ester residue | 1200 |
| P-71 | 2,8-NPA | AA/SA | 20/40/40 | ethane diol | 100 | acetyl ester residue | 1200 |

In Table 1 and Table 2, PA means phthalic acid, TPA means terephthalic acid, IPA means isophthalic acid, AA means adipic acid, SA means succinic acid, 2,6-NPA means 2,6-naphthalenedicarboxylic acid, 2,8-NPA means 2,8-naphthalenedicarboxylic acid, 1,5-NPA means 1,5-naphthalenedicarboxylic acid, 1,4-NPA means 1,4-naphthalenedicarboxylic acid, 1,8-NPA means 1,8-naphthalenedicarboxylic acid.

### <Low-Molecular-Weight Additive>

The low-molecular-weight additive includes retardation reducer/regulator, release promoter, mat agent, low-molecular-weight plasticizer, IR absorbent, antioxidant, UV inhibitor, etc. These may be solid or oily. Specifically, they are not specifically defined in point of the melting point or the boiling point thereof. For example, a UV absorbent material having a melting point of 20° C. or lower and that having a melting point of not lower than 20° C. may be mixed; or similarly, antioxidants may be mixed. UV absorbing dyes are described in, for example, JP-A 2001-194522. Regarding the time for addition, the additive may be added in any stage of a process of preparing a cellulose acylate solution (dope), or the dope preparing process may be followed by an additional step for additive addition. The amount of the additive is not specifically defined so far as the added additive can exhibit its function.

The optical film of the invention may contain a retardation reducer, and the retardation reducer is not specifically defined.

Preferably, the retardation reducer is added in a ratio of from 0.01 to 30% by mass relative to the cellulose resin, more preferably from 0.1 to 20% by mass, even more preferably from 0.1 to 10% by mass. When the amount is at most 30% by mass, then the compatibility of the agent with the cellulose resin may be enhanced and the film may be prevented from being whitened. In case where two or more different types of retardation reducers are used as combined, their total amount preferably falls within the above range.

### (Retardation Regulator)

The optical film of the invention may contain a retardation regulator; and from the viewpoint of increasing the value of Rth/Re, concretely preferred is a compound having at least one aromatic ring, more preferably having from 2 to 15 aromatic rings, even more preferably having from 3 to 10 aromatic rings. Preferably, the other atoms than those constituting the aromatic rings in the compound are in a configuration near to the same plane as that of the aromatic ring; and in case where the compound has plural aromatic rings, the plural aromatic rings are preferably in a configuration near to one and the same plane. For selectively increasing Rth of the film, preferably, the additive in the film is in such a manner that the face of the aromatic ring in the additive compound lies in the direction parallel to the face of the film. Specific examples of the compound are described, for example, in JP-A 2006-235483, pp. 6-38, as “retardation enhancers”; and these may be suitably used in the present invention. Above all, a compound having the following structure is especially preferred for use in the invention.

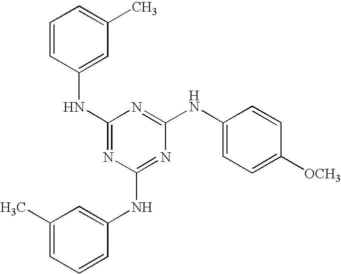

Preferably, a release promoter is added to the film of the invention. The release promoter may be added to the film, for example, in a ratio of from 0.001 to 1% by weight. As the release promoter, for example, preferred are the compounds described in JP-A 2006-45497, paragraphs [0048] to [0069]. In case where the film of the invention has a two-layer or more multilayer laminate structure, the release promoter is preferably added to the skin B layer from the viewpoint of improving the releasability of the formed film from the support in formation of the film by solution casting.

Preferably, fine particles serving as a mat agent are added to the film of the invention. The fine particles usable in the invention include silicon dioxide, titanium dioxide, aluminium oxide, zirconium oxide, calcium carbonate, talc, clay, fired kaolin, fired calcium silicate, calcium silicate hydrate, aluminium silicate, magnesium silicate and calcium phosphate. Preferably, the fine particles contain silicon as their turbidity is low; and silicon dioxide is more preferred. The fine particles of silicon dioxide preferably have a mean primary particle size of at most 20 nm, and an apparent specific gravity of at least 70 g/liter. Those having a small mean primary particle size of from 5 to 16 nm are more preferred as they can lower the haze of the film. The apparent specific gravity is more preferably from 90 to 200 g/liter or more, even more preferably from 100 to 200 g/liter or more. The fine particles having a larger apparent specific gravity are preferred since they can form a dispersion having a high concentration and since they can reduce the haze of the film and can prevent formation of coarse aggregates. In case where the film of the invention has a two-layer laminate structure, the release promoter is preferably added to the skin B layer from the viewpoint of enhancing the releasability of the film. In case where the film of the invention has a three-layer or more multilayer laminate structure, the release promoter is preferably added to the skin B layer or the skin A layer from the viewpoint of preventing the film from being curled.

These fine particles generally form secondary particles having a mean particle size of from 0.1 to 3.0 μm, and these fine particles exist in the film as aggregates of the primary particles thereof, making the film surface have irregularities of from 0.1 to 3.0 μm therein. Preferably, the mean secondary particle size is from 0.2 μm to 1.5 μm, more preferably from 0.4 μm to 1.2 μm, most preferably from 0.6 μm to 1.1 μm. To measure the primary and secondary particle size thereof, the particles in the film are observed with a scanning electronic microscope and the diameter of the circumscribed circle of the particle is taken as the particle size. 200 particles are analyzed at different sites, and their data are averaged to give the mean particle size.

As the fine particles of silicon dioxide, herein usable are commercial products of, for example, Aerosil R972, R972V, R974, R812, 200, 200V, 300, R202, OX50, TT600 (all by Nippon Aerosil), etc. The fine particles of zirconium oxide for use herein are available as commercial products of, for example, Aerosil R976 and R811 (by Nippon Aerosil).

Of those, preferred are fine particles of silicon dioxides, Aerosil 200V and Aerosil R972V having a mean primary particle size of not more than 20 nm and an apparent specific gravity of not less than 70 g/liter as they are effective for reducing the frictional coefficient of the optical film while keeping the turbidity thereof low.

In order to make the film of the invention contain particles having a small mean secondary particle size, some methods may be employed for preparing the dispersion of fine particles. For example, one method comprises previously preparing a dispersion of fine particles by stirring and mixing a solvent and fine particles, then adding the dispersion of fine particles to a small amount of a cellulose acylate solution separately prepared, stirring and dissolving it, and mixing the resulting solution with a main cellulose acylate dope solution. The method is preferred in that the silicon dioxide fine particles can be well dispersed and the silicon dioxide fine particles hardly re-aggregate. Apart from it, another method comprises adding a small amount of a cellulose ester to a solvent, stirring and dissolving it, then adding fine particles thereto and dispersing in a disperser to prepare an additive dispersion of fine particles, and adding the additive dispersion of fine particles to a dope solution and well mixing them by the use of an in-line mixer. The invention is not limited to these methods. In mixing and dispersing silicon dioxide fine particles in a solvent, the concentration of silicon dioxide is preferably from 5 to 30% by mass, more preferably from 10 to 25% by mass, most preferably from 15 to 20% by mass. The concentration in the dispersion is preferably higher, since the liquid turbidity is lower relative to the amount of the dispersion added to the film, and the haze of the film may be reduced and few aggregates may be formed in the film. The amount of the mat agent to be in the final cellulose acylate dope solution is preferably from 0.01 to 1.0 g/m², more preferably from 0.03 to 0.3 g/m², most preferably from 0.08 to 0.16 g/m².

Lower alcohols are usable as the solvent. Preferred are methyl alcohol, ethyl alcohol, propyl alcohol, isopropyl alcohol, butyl alcohol, etc. Other solvents than lower alcohols are not specifically defined. Preferably used is the solvent used in film formation with cellulose ester.

The film of the invention may contain a low-molecular-weight plasticizer. The low-molecular-weight plasticizer is, for example, an ester-type plasticizer. Preferred are those more hydrophobic than cellulose acylate, for example, phosphates such as triphenyl phosphate (TPP), tricresyl phosphate, cresyldiphenyl phosphate, octyldiphenyl phosphate, diphenylbiphenyl phosphate, trioctyl phosphate, tributyl phosphate, butylphenyldiphenyl phosphate (BDP), etc.; phthalates such as diethyl phthalate, dimethoxyethyl phthalate, dimethyl phthalate, dioctyl phthalate, dibutyl phthalate, di-2-ethylhexyl phthalate, etc.; glycolates such as triacetin, tributyrin, butylphthalylbutyl glycolate, ethylphthalylethyl glycolate, methylphthalylethyl glycolate, butylphthalylbutyl glycolate, etc. One or more of these may be used either singly or as combined. Of those, more preferred is at least one selected from phosphate-type plasticizers, phthalate-type plasticizers and glycolate-type plasticizers; and even more preferred are those containing a phosphate-type plasticizer. If desired, two or more different types of these plasticizers may be used as combined.

The low-molecular-weight plasticizer may serve also as an Rth regulator.

### [Method for Producing Cellulose Acylate Film]

The method for producing the cellulose acylate laminate film of the invention (hereinafter this may be referred to as the production method of the invention) comprises stretching a cellulose acylate film at a temperature satisfying the following formula (8), followed by processing the stretched film for wet heat treatment under the condition satisfying the following formulae (9) and (10):

Te−30° C.≦(stretching temperature)≦Te+30° C. (8)

Te=T[tan δ ]−ΔTm (8′)

ΔTm=Tm(0)−Tm(x) (8″),

in formula (8), T[tan δ] means a temperature at which tan δ shows a peak, and tan δ means the dynamic viscoelasticity of the cellulose acylate in which the residual solvent amount is 0%; Tm(0) means the crystal melting temperature of the cellulose acylate in which the residual solvent amount is 0%; Tm(x) means the crystal melting temperature of the cellulose acylate in which the residual solvent amount is x %,

60° C.≦(wet heat treatment temperature)≦130° C. (9)

200 g/m³≦(absolute humidity in wet heat treatment)≦500 g/m³ (10).

The details of the production method of the invention are described in order.

### (Preparation of Dope)

In the producing method of the invention, the film of the invention is produced according to a solvent casting method. In the solvent casting method, the film is produced with a solution (dope) in which a cellulose acylate is dissolved in organic solvents.

The organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers, esters and ketones (i.e., —O—, —CO— and —COO—) are also usable herein as the organic solvent; and they may have any other functional group such as an alcoholic hydroxyl group. In case where the organic solvent has two or more functional groups, the number of the carbon atoms constituting them may fall within a range of the number of carbon atoms that constitute the compound having any of those functional groups.

Examples of the ethers having 3-12 carbon atoms are diisopropyl ether, dimethoxymethane, dimethoxyethane, 1,4-dioxane, 1,3-dioxolane, tetrahydrofuran, anisole and phenetole.

Examples of the ketones having 3-12 carbon atoms are acetone, methyl ethyl ketone, diethyl ketone, diisobutyl ketone, cyclohexanone, methylcyclohexanone.

Examples of the esters having 3-12 carbon atoms are ethyl formate, propyl formate, pentyl formate, methyl acetate, ethyl acetate, pentyl acetate.

Examples of the organic solvents having plural functional groups are 2-ethoxyethyl acetate, 2-methoxyethanol and 2-butoxyethanol.

The number of the carbon atoms constituting the halogenohydrocarbon is preferably 1 or 2, most preferably 1. The halogen in the halogenohydrocarbon is preferably chlorine. The proportion of the hydrogen atoms in the halogenohydrocarbon substituted with a halogen is preferably from 25 to 75 mol %, more preferably from 30 to 70 mol %, even more preferably from 35 to 65 mol %, most preferably from 90 to 60 mol %. Methylene chloride is a typical halogenohydrocarbon.

Two or more different types of organic solvents may be mixed for use in the invention.

The cellulose acylate solution may be prepared according to an ordinary method. In one general method, the solution is processed at a temperature not lower than 0° C. (room temperature or high temperature). For preparing the solution, employable is a method and an apparatus for dope preparation according to an ordinary solvent casting method. In the ordinary method, preferably used is a halogenohydrocarbon (especially methylene chloride) as the organic solvent.

The amount of the cellulose acylate is so controlled that it may be in the solution in an amount of from 10 to 40% by mass. The amount of the cellulose acylate is preferably from 10 to 30% by mass. To the organic solvent (main solvent), polymer X and any additives mentioned above can be added.

The solution is prepared by stirring a cellulose acylate and an organic solvent at room temperature (0 to 40° C.). A high-concentration solution may be stirred under pressure and under heat. Concretely, a cellulose acylate and an organic solvent are put into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber after roughly premixed. They may be put into the chamber one after another. The chamber must be so planned that the contents therein could be stirred. An inert gas such as nitrogen gas or the like may be introduced into the chamber to pressurize it. The solvent vapor pressure may increase under heat, and this may be utilized in process. Alternatively, after the chamber is closed, the ingredients may be introduced thereinto under pressure.

Preferably, the contents in the chamber are heated in an external heating mode. For example, a jacket type heating unit may be used. A plate heater may be disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope may be cooled with a heat exchanger or the like.

### (Co-Casting)

In preparing a laminate film, it is also preferable to produce a cellulose acylate laminate film from two or more kind of the thus-prepared cellulose acylate solution (dope) according to a solvent casting method.

The dope is cast on a drum or a band, on which the solvent is evaporated away to form a film. Before case, the concentration of the dope is preferably so planned that the solid content thereof is from 18 to 35% by mass. Preferably, the surface of the drum or the band is finished to be a mirror face. The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Preferably, the dope is cast on a drum or a band at a surface temperature of not higher than 10° C. After thus cast, preferably, this is dried by exposing to air for at least 2 seconds. The formed film is peeled away from the drum or the band, and then it may be dried with high-temperature air of which the temperature is stepwise changed from 100° C. to 160° C. to thereby remove the residual solvent by vaporization. This method is described in JP-B 5-17844. According to the method, the time to be taken from the casting to the peeling may be shortened. In carrying out the method, the dope must be gelled at the surface temperature of the drum or the band on which it is cast.

In the invention, the prepared cellulose acylate solution may be cast onto a smooth band or drum serving as a metal support, as a single-layer solution; or plural cellulose acylate solutions for 2 or more layers may be co-cast thereon. In case where plural cellulose acylate solutions are co-cast, the cellulose acylate-containing solution may be cast onto a metal support through plural casting mouths disposed around the support at intervals in the machine direction, and the co-cast solutions may be laminated on the support to give a film. For example, the methods described in JP-A 61-158414, 1-122419, 11-198285 are employable. The cellulose acylate solution may be cast through two casting mouths to form a film, for which, for example, employable are the methods described in JP-B 60-27562, JP-A 61-94724, 61-947245, 61-104813, 61-158413, 6-134933. Also employable herein is a cellulose acylate film co-casting method of casting a flow of a high-viscosity cellulose acylate solution as enveloped with a low-viscosity cellulose acylate solution thereby simultaneously extruding both the high-viscosity and low-viscosity cellulose acylate solutions, as in JP-A 56-162617. Preferred is an embodiment where the outer solution contains a larger amount of a poor solvent, alcohol than in the inner solution, as in JP-A 61-94724, 61-94725.

Two casting mouths may be used as follows: A film is formed on a metal support through the first casting mouth, then this is peeled, and on the other surface of the film opposite to that having kept in contact with the metal support, another film is formed through the second casting mouth. For example, the method is described in JP-B 44-20235. The cellulose acylate solutions to be cast may be the same or different with no specific limitation. In order to make the plural cellulose acylate layers have various functions, cellulose acylate solutions corresponding to the desired functions may be cast through the respective casting mouths. The cellulose acylate solution, in the present invention, may be cast along with any other functional layers (e.g., adhesive layer, dye layer, antistatic layer, antihalation layer, UV absorbent layer, polarizing layer). In the producing method of the invention, a step for casting is a simultaneously or successively multilayer-casting.

In case where a single-layer film is formed according to a conventional technique, a high-concentration and high-viscosity cellulose acylate solution must be extruded out in order to make the formed film have a desired thickness; but in such a case, the stability of the cellulose acylate solution is poor therefore causing various problems of solid deposition to be fish eyes or to roughen the surface of the film. For solving the problems, plural cellulose acylate solutions are cast out through different casting mouths, whereby high-density solutions can be extruded out at the same time on a metal support, and as a result, the surface properties of the formed films are bettered and films having excellent surface properties can be produced. In addition, since such thick cellulose acylate solutions can be used and the drying load in the process can be reduced, and the film producibility is enhanced.

In co-casting, the thickness of the inner layer and the surface layer is not specifically defined. Preferably, the surface layer accounts for from 1 to 50% of the overall film thickness, more preferably from 2 to 30%. In co-casting of three or more layers, the total thickness of the surface layer in contact with the metal support and the surface layer in contact with air is defined as the thickness of the surface layer.

In another embodiment of co-casting, cellulose acylate solutions in which the density of the additives such as the above-mentioned plasticizer, UV absorbent, matting agent and the like differs may be co-cast to produce a cellulose acylate film having a laminate structure. For example, a cellulose acylate film having a constitution of skin layer B/core layer/skin layer A can be produced. For example, the matting agent may be much in the skin layer B, or may be only in the skin layer B. The plasticizer and the UV absorbent may be more in the core layer than in the skin layers, or may be only in the core layer. The type of the plasticizer and the UV absorbent may differ between the core layer and the skin layers. For example, a low-volatile plasticizer and/or UV absorbent may be in the skin layers, and a plasticizer of excellent plasticization or a UV absorbent of excellent UV absorption may be added to the core layer. An embodiment of adding a release agent to only the skin layer (the skin layer B) on the side of the metal support is also preferred. In order to gel the solution by cooling the metal support in a cooling drum method, a poor solvent, alcohol may be more in the skin layers than in the core layer, and this is also a preferred embodiment. Tg may differ between the skin layers and the core layer. Preferably, Tg of the skin layers is lower than that of the core layer. The viscosity of the cellulose acylate solution to be cast may differ between the skin layers and the core layer. Preferably, the viscosity of the solution for the skin layers is smaller than that for the core layer; however, the viscosity of the solution for the core layer may be smaller than that for the skin layers.

In the film production method of the invention, a single-layer film can be produced, of which the wavelength dispersion ΔRe satisfies the above formula (1) and the dimensional change satisfies the above formula (2), not co-casting cellulose acylate dopes; but co-casting cellulose acylate dopes, a cellulose acylate laminate film can be produced, of which the wavelength dispersion ΔRe satisfies the above formula (1) and the dimensional change satisfies the above formula (2). The preferred embodiments of the degree of acyl substitution in the cellulose acylate to form the constitutive layers may be the same as those of the degree of acyl substitution in the cellulose acylate forming the constitutive layers of the film of the invention described in the above.

In the invention, the single-layer or multilayer cast dope is dried and peeled from the support.

### (Drying)

A method of drying the web that is dried on a drum or belt and is peeled away from it is not particularly limited. The web peeled away at the peeling position just before one lap of the drum or the belt is conveyed according to a method where the web is led to pass alternately through rolls disposed like a houndstooth check, or according to a method where the peeled web is conveyed in a non-contact mode while both sides of the web are held by clips or the like. The drying may be attained according to a method where air at a predetermined temperature is given to both surfaces of the web (film) being conveyed, or according to a method of using a heating means such as microwaves, etc. Rapid drying may damage the surface smoothness of the formed film. Therefore, in the initial stage of drying, the web is dried at a temperature at which the solvent does not bubble, and after having gone on in some degree, the drying may be preferably attained at a high temperature. In the drying step after peeled away from the support, the film tends to shrink in the machine direction or in the cross direction owing to solvent evaporation. The shrinkage may be larger in drying at a higher temperature. Preferably, the shrinkage is inhibited as much as possible for bettering the surface condition of the film to be formed. From this viewpoint, for example, preferred is a method (tenter method) where the entire drying step or a part of the drying step is carried out with both sides of the web held with clips or pins so as to keep the width of the web, as in JP-A 62-46625. The drying temperature in the drying step is preferably from 100 to 145° C. The drying temperature, the drying air amount and the drying time may vary depending on the solvent used, and are therefore suitably selected in accordance with the type and the combination of the solvent to be used.

### (Stretching)

The production method of the invention includes, after the step of drying the dope in some degree and peeling it from the support, a step of stretching the peeled film, which contains a residual solvent in an amount of x % by mass relative to the cellulose acylate in the dope, at a temperature satisfying the following formula (8):

Te−30° C.≦(stretching temperature)≦Te+30° C. (8)

Te=T[tan δ]−ΔTm (8′)

ΔTm=Tm(0)−Tm(x) (8″)

Changing the stretching temperature in accordance with the residual solvent amount in the film being stretched is one characteristic feature of the invention. The production method of the invention is based on the finding that, when the stretching temperature is not lower than Te−30° C., then the dimensional change of the obtained film left in a wet heat environment is significantly reduced. When the stretching temperature is not higher than Te+30° C., then the method is favorable since the dimensional change of the obtained film left in a wet heat environment is fully reduced to be enough for practical use and since the cellulose acylate resin and the additives are prevented from being thermally decomposed.

In addition, when the stretching temperature is controlled to fall within the range of formula (8), then the wavelength dispersion ΔRe of the obtained film can readily satisfy the range of the above-mentioned formula (1).

In case where the residual solvent amount in the film being stretched is 0% by mass relative to the cellulose acylate in the dope, Te=T [tan δ], and therefore in that case, the film is stretched at a stretching temperature satisfying the condition of T[tan δ]−30° C.≦(stretching temperature)≦T[tan δ]+30° C.

T[tan δ] means a temperature at which tan δ shows a peak, and tan δ means the dynamic viscoelasticity, as measured with Vibron, of cellulose acylate in which the residual solvent amount is 0%. Vibron for use in measuring the dynamic viscoelasticity is not specifically defined, for which, for example, usable is IT Keisoku Seigyo's Model DVA200.

Tm(0) means the crystal melting temperature of cellulose acylate in which the residual solvent amount is 0%; and Tm(x) means the crystal melting temperature of cellulose acylate in which the residual solvent amount is x %. In general, the relationship between the residual solvent amount in the peeled film and the crystal melting temperature Tm of the film is such that Tm lowers with the increase in the residual solvent amount. For measuring the crystal melting temperature, employable is any known method with DSC, and for example, the temperature may be measured according to the method described in Disclosure Bulletin No. 2001-1745, pp. 11-12.

T[tan δ] could not be determined with a film containing a residual solvent. However, in case where the stretching temperature satisfies the formula (8) defined in the invention, the dimensional change of even a film containing a residual solvent can be significantly reduced when the film is aged in a wet heat environment. Not adhering to any theory, when the film is stretched at a stretching temperature regulated according to the formulae (8) and (8′) in consideration of the fact that the residual solvent may have an influence on the film stretching by ΔTm determined according to the above formula (8″), surprisingly the dimensional change of the stretched film is remarkably reduced even though the film contains a residual solvent.

In the film production method of the invention, the stretching temperature may be controlled depending on the residual solvent amount in the film being stretched, and therefore, though the residual solvent amount in the film to be stretched is not specifically defined, it is desirable that the film peeled from a support is stretched while the residual solvent amount in the film is less than 120% by mass.

The residual solvent amount may be represented as follows:

Residual Solvent Amount(% by mass)=(M−N)/N}×100.

In this, M means the mass of the web at any time, N means the mass of the web of which M is measured and which is dried at 110° C. for 3 hours. When the residual solvent amount in the web is too much, the film could hardly enjoy the stretching effect, and therefore, the residual solvent amount in the film being stretched is more preferably from 0% by mass to 80% by mass, even more preferably from 0% by mass to 60% by mass. In case where the draw ratio in stretching is too small, the stretched film could not have sufficient retardation Re and Rth; but when too large, the stretching may be difficult and the film being stretched may be cut or broken.

Preferably in the production method of the invention, a cellulose acylate film satisfying the following formulae (5) and (11) is stretched at a temperature satisfying the following formula (12) from the viewpoint of reducing the dimensional change of the low-substitution cellulose acylate film.

2.3≦A+B≦2.6 (5)

B=0 (11)

In formulae (5) and (11), A means the degree of substitution with an acetyl group in the cellulose acylate; and B means the degree of substitution with a propionyl group or a butyryl group in the cellulose acylate.

Te−20° C.≦(stretching temperature)≦Te+20° C. (12)

Te=T[tan δ]−ΔTm (12′)

ΔTm=Tm(0)−Tm(x) (12″)

In the invention, the film formed by solution casting may be stretched even when it is not heated at a high temperature so far as the residual solvent amount in the film is controlled to fall within a specific range; however, the film is preferably dried and stretched at the same time for saving the process. Specifically, the film may be stretched while a solvent still remains therein, or the film may be stretched after dried.

The film is effectively stretched in two axial directions perpendicular to each other for the purpose of controlling Re and Rth of the stretched film to fall within the range of the invention. For example, when the film is stretched in the casting direction and when the shrinkage in the cross direction of the stretched film is too large, then the value Nz of the film may be large. In this case, the lateral shrinkage of the film is prevented or the film is stretched also in the cross direction, and the film is thereby improved. In case where the film is stretched in the cross direction, the refractive index of the film may have a distribution in the cross direction. This is often seen in a case of using a tenter method for film stretching. As stretched in the cross direction, the center of the film is shrunk while the sides thereof are fixed, and this may be a so-called bowing phenomenon. Even in this case, the bowing phenomenon may be prevented by stretching the film in the casting direction, and therefore the retardation distribution in the cross direction can be reduced. Further, the thickness fluctuation to occur in stretching the film in two axial directions perpendicular to each other can be reduced. In case where the thickness fluctuation of an optical film is too large, then the retardation of the film may be uneven. The thickness fluctuation of the stretched film is preferably within a range of ±3%, more preferably within a range of ±1%.

In the object as above, the method of stretching the film in two axial directions perpendicular to each other is effective, and the draw ratio in stretching in two axial directions perpendicular to each other is preferably from 1.2 to 2.0 times each, more preferably from 0.7 to 1.0 time each. The stretching at a ratio of from 1.2 to 2.0 times in one direction and at a ratio of from 0.7 to 1.0 time in the other perpendicular direction means that the distance between the clips or pins to support the film is controlled to fall within a range of from 0.7 to 1.0 times relative to the distance therebetween of the film before stretching.

In general, in case where the film is stretched in the cross direction by 1.2 to 2.0 times, using a biaxial stretching tenter, a shrinking force acts on the perpendicular direction thereof, or that is, on the machine direction of the film.

Accordingly, when the film is stretched while a force is kept applied only in one direction, then the width of the film in the other direction perpendicular to that one direction may shrink. The method means that the shrinking degree is controlled without control of the width of the film, or that is, this means that the distance between the clips or the pins for width control is defined to be from 0.7 to 1.0 time the distance therebetween before stretching. In this case, a force of shrinking the film in the machine direction acts on the film owing to the stretching in the cross direction. The distance kept between the clips or the pins in the machine direction makes it possible to prevent any unnecessary tension from being given to the film in the machine direction thereof. The method of stretching the web is not specifically defined. For example, there are mentioned a method of providing plural rolls each running at a different peripheral speed and stretching the film in the machine direction based on the peripheral speed difference between the rolls, a method of holding both sides of the web with clips or pins and expanding the distance between the clips or pins in the machine direction to thereby stretch the film in the machine direction, or expanding the distance therebetween in the cross direction to thereby stretch the film in the cross direction, and a method of expanding the distance both in the machine direction and in the cross direction to thereby stretch film in both the machine and cross directions. Needless-to-say, these methods may be combined. In the so-called tenter method, preferably, the clip parts are driven according to a linear driving system, by which the film may be smoothly stretched with little risk of breaking, etc.

The producing method of the invention preferably includes a step of again stretching the film after the step of peeling and stretching the film, from the view point of improving the optical expressibility, particularly enlarging the optical expressibility range by reducing the Nz factor, etc.

### (Wet Heat Treatment)

The production method of the invention includes a step of processing the film stretched at the temperature satisfying the formula (8), for wet heat treatment (steam contact treatment) under the condition satisfying the following formulae (9) and (10):

60° C.≦(wet heat treatment temperature)≦130° C. (9)

200 g/m³≦(absolute humidity in wet heat treatment)≦500 g/m³ (10)

Even through the film is stretched under the condition satisfying the above formula (8) and therefore the stretched film could have the reversed wavelength dispersion characteristics of retardation satisfying the above formula (1), the problem of dimensional change of the film when aged in a wet heat environment could not still be solved. Not adhering to any theory, when a film having a large dimensional change is incorporated into a liquid-crystal display device, the problem to occur may be caused by the irreversible change of the film dimension when the device is left, for example, at 60° C. and 90% RH for a long period of time. The production method of the invention has solved the problem, in which the stretched film is processed for wet heat treatment under the condition satisfying the above formulae (9) and (10) to thereby positively produce the irreversible change in the film.

When the wet heat treatment under the specific condition is applied to a conventional stretched film, or that is, when the treatment is applied to a film which is stretched at a temperature not falling within the range of the invention and which therefore has a large dimensional change, then the film may be wrinkled. As a result, the obtained film is problematic in point of the optical properties thereof including the wavelength dispersion characteristics of retardation thereof, and in addition, the film could not be well handled. According to the production method of the invention, the film which is stretched at the temperature satisfying the above formula (8) and of which the dimensional change is therefore reduced in some degree is specifically processed for wet heat treatment, whereby contrary to conventional knowledge and unexpectedly, a film regulated to have the intended wavelength dispersion of the invention and to have a reduced dimensional change as intended in the invention can be obtained. Further, the film obtained according to the preferred embodiment of the production method of the invention can have favorably regulated optical properties suitable for retardation films for liquid-crystal display devices.

Preferably, the wet heat treatment temperature is from 70 to 125° C., more preferably from 80 to 120° C. The wet heat treatment temperature as referred to herein is the temperature of the cellulose acylate film after kept in contact with the contact vapor.

The absolute humidity in the wet heat treatment is preferably from 250 to 400 g/m³, more preferably from 280 to 390 g/m³.

The relative humidity of the contact vapor is preferably from 10% to 100%, more preferably from 15 to 100%, even more preferably from 20 to 100%.

### (Contact Vapor)

The vapor (contact vapor) to be kept into contact with the cellulose acylate film in the wet heat treatment step is a vapor containing steam, preferably a vapor containing steam as the main ingredient thereof, and more preferably, the contact vapor is steam. The vapor as the main ingredient as referred to herein means that, when the vapor is composed of a single vapor, the main ingredient is the single vapor itself, and when the vapor is composed of plural vapors, the main ingredient is the vapor having the largest mass fraction of all the constitutive vapors.

Preferably, the contact vapor is formed in a wet vapor supply apparatus. Concretely, a liquid solvent is heated in a boiler to be a vapor and then this is fed via a blower. The contact vapor may be suitably mixed with air, and after fed via a blower, the vapor may be further heated in a heating device. The air is preferably heated one. The temperature of the thus-generated contact vapor is preferably from 70 to 200° C., more preferably from 80 to 160° C., most preferably from 100 to 140° C. When the temperature is higher than the uppermost limit temperature, it is unfavorable since the film may strongly curl; and when lower than the lowermost limit temperature, the treatment could not yield a sufficient result.

### (Contact Step)

As the contact method for the cellulose acylate film and the above-mentioned contact vapor in the wet heat treatment step, employable is a method of applying the contact vapor to the cellulose acylate film, or a method of putting the cellulose acylate film in a space filled with the contact vapor, or a method of leading the cellulose acylate film to pass through a space filled with the contact vapor. Preferred is the method of applying the contact vapor to the cellulose acylate film, or the method of leading the cellulose acylate film to pass through a space filled with the contact vapor. Regarding the contacting mode, preferably, the cellulose acylate is kept in contact with the contact vapor while guided by zigzag aligned plural rollers.

The contact time with the contact vapor is not specifically defined. Within the range within which the effect of the invention can be attained, the contact time is preferably shorter from the viewpoint of the production efficiency. The uppermost limit of the treatment time is, for example, preferably at most 60 minutes, more preferably at most 10 minutes. On the other hand, the lowermost limit of the treatment time is, for example, preferably at least 10 seconds, more preferably at least 30 seconds.

The temperature of the cellulose acylate film before brought into contact with the contact vapor is not specifically defined, but is preferably from 80 to 130° C.

The residual solvent amount in the cellulose acylate film before the wet heat treatment is not specifically defined. Preferably, the flowability of the cellulose acylate molecules is almost lost, and the residual solvent amount is preferably from 0 to 5% by mass, more preferably from 0 to 0.3% by mass.

After contacted with the cellulose acylate film, the contact vapor may be fed into a condensation device to which a cooling device is connected, and in this, the vapor may be separated into a hot vapor and a condensed liquid.

In the production method of the invention, more preferably, a cellulose acylate film having a degree of acyl substitution satisfying the above formulae (5) and (11) is stretched at a temperature satisfying the above formula (12), and then processed for wet heat treatment under the condition satisfying the following formulae (13) and (14), from the viewpoint of more effectively reducing the dimensional change of the low-substitution cellulose acylate film.

70° C.≦(wet heat treatment temperature)≦120° C. (13)

250 g/m³≦(absolute humidity in wet heat treatment)≦400 g/m³ (14)

The more preferred embodiment of the production method of the invention is based on the finding that, when a low-substitution cellulose acylate film is processed for wet heat treatment, the absolute humidity must be strictly controlled. For example, in case where the absolute humidity that is considered the best for a cellulose acylate film having a degree of acyl substitution of around 2.9 is applied to a low-substitution cellulose acylate film, then the film is greatly stretched in the machine direction in the wet heat treatment step. The preferred range of the wet heat treatment temperature, the absolute humidity and the relative humidity for the low-substitution cellulose acylate film may be the same as the preferred range in wet heat treatment of the films with no specific limitation on the degree of substitution.

### (Drying Step)

The cellulose acylate film thus kept in contact with the contact vapor may be directly cooled to around room temperature, or may be transferred into a drying zone for controlling the amount of the contact vapor molecules remaining in the film. In case where the film is transferred into a drying zone, preferably employed is a method of applying hot air or warm air or air having a low vapor concentration to the cellulose acylate film being carried on rolls or to the cellulose acylate film being carried while clipped with a tenter on both sides thereof, or a method of irradiating the film with heat rays, or a method of contacting the film with a heated roll. Preferred is the method of applying hot air or warm air or air having a low vapor concentration to the film. In case where a step of contacting the film with steam is taken prior to the heat treatment step, the heat treatment step could be the drying step.

### (Heat Treatment Step)

Preferably, the film production method of the invention includes the above-mentioned heat treatment step after the wet heat treatment step. In the invention, the heat treatment may be attained after the wet heat treatment step and before the drying step, or the heat treatment step after the wet heat treatment step may serve also as the drying step, or after the wet heat treatment step and the drying step, the film is once wound up according to the method to be mentioned below, and it may be rewound and then additionally processed in a separate heat treatment step. In the invention, preferably, the heat treatment step is provided after the wet heat treatment step and before the drying step. This mode is more advantageous in that a film having more excellent thermal dimension stability can be obtained.

Though not clear, the reason why the shrinkage of the film could be reduced through the treatment may be presumed as follows: The film stretched in the stretching step may have large residual stress in the stretching direction, but the residual stress is removed by the heat treatment, and therefore, the contraction force in the region not higher than the heat treatment temperature may be reduced.

The heat treatment may be attained by a method of applying air at a predetermined temperature to the film being transferred, or a method of using a heating means such as microwaves or the like.

During heat treatment and drying, the absolute humidity is preferably 0 g/m³. The heat treatment temperature in the heat treatment step is preferably the same temperature as in the wet heat treatment step from the viewpoint of preventing dew condensation and film shrinkage.

In the heat treatment step, the film shrinks in the machine direction or the cross direction. Preferably, the shrinkage is prevented as much as possible during the heat treatment for the purpose of enhancing the surface smoothness of the finished film. Accordingly, preferred is a method of holding both sides of the film with clips or pins in the cross direction to keep the width of the film during heat treatment (tenter method). Also preferably, the film is stretched by from 0.9 times to 1.5 times in both the cross direction and the machine direction of the film.

For winding the obtained film, usable is any ordinary winding machine. The film may be wound according to various winding methods such as a constant tension method, a constant torque method, a tapered tension method or a programmed tension control method in which the internal stress is kept constant. Preferably, in the optical film roll thus produced in the manner as above, the slow axis direction is within ±2 degrees relative to the winding direction (machine direction) of the film, more preferably within ±1 degree. Also preferably, the direction is within ±2 degrees relative to the direction perpendicular to the winding direction (cross direction of the film), more preferably within ±1 degree. Even more preferably, the slow axis direction of the film is within ±0.1 degrees relative to the winding direction (machine direction) of the film, or is within ±0.1 degrees relative to the cross direction of the film.

### (Retardation Film, Polarizer)

The film of the invention is preferably used as a retardation film for polarizer. A polarizer is formed by sticking and laminating a protective film on at least one surface of a polarizing element. The polarizing element may be a conventional known one. For example, it is produced by processing a hydrophilic polymer film such as a polyvinyl alcohol film with a dichroic dye such as iodine followed by stretching it. The cellulose ester film may be stuck to the polarizing element in any manner with no specific limitation thereon, for which, for example, an adhesive comprising an aqueous solution of a water-soluble polymer may be used. Preferably, the water-soluble polymer adhesive is an aqueous solution of a completely-saponified polyvinyl alcohol.

### (Liquid-Crystal Display Device)

The film of the invention is preferably used in a liquid-crystal display device. In particular, the film may be stuck to a TN-mode, VA-mode, OCB-mode or the like liquid-crystal cell, thereby providing a liquid-crystal display device having excellent viewing angle characteristics and excellent visibility with little coloration. In particular, the polarizer comprising the film of the invention is remarkably improved in that it prevents light leakage at the time of black level of display under a high-temperature high-humidity condition, and it degrades little and therefore maintains stable performance for a long period of time.

### Examples

The present invention will be further specifically explained with reference to the following examples of the present invention. The materials, amounts, ratios, types and procedures of treatments and so forth shown in the following examples can be suitably changed unless such changes depart from the gist of the present invention. Accordingly, the scope of the present invention should not be construed as limited to the following specific examples.

### (Preparation of Cellulose Acylate)

According to the method described in JP-A 10-45804 and 08-231761, a cellulose acylate was produced, and its degree of substitution was measured. Concretely, as a catalyst, sulfuric acid was added in an amount of 7.8 parts by mass relative to 100 parts by mass of cellulose, and a carboxylic acid as a material for the acyl group was added for acylation at 40° C. In this process, the type and the amount of the carboxylic acid were controlled to thereby control the type and the degree of acyl substitution. After the acylation, the product was ripened at 40° C. The low-molecular-weight ingredient of the cellulose acylate was washed away with acetone.

### (Production of Film)

The production method for cellulose acylate films in the Examples is described below.

### Examples 1 to 9, 11, Comparative Examples 1 to 8

The formulation of the compounds used in preparing a starting material dope is mentioned below.

A solid ingredient (solute) comprising:

| | |
|---|---|
| Cellulose acylate (having a degree of substitution | 89.3 parts by mass, |
| shown in Table 3) | |
| Additive (the compound and the amount are shown | |
| (unit, part by mass), in Table 3) was suitably added | |
| to a mixed solven comprising: | |
| Dichloromethane | 82 parts by mass, |
| Methanol | 13.5 parts by mass, |

and stirred and dissolved to prepare a starting material dope.

The starting material dope was so controlled that the cellulose acylate concentration therein could be 22% by weight. The starting material dope was filtered through filter paper (Toyo Filter Paper's #63LB), then through a sintered metal filter (Nippon Seisen's 06N, having a nominal pore size of 10 μm) and further through a mesh filter, and thereafter put into a stock tank.

In Table 3, CA means cellulose acetate, CAP means cellulose acetate propionate. In Comparative Example 3, COP means cycloolefin polymer (Nippon Zeon's trade name, ZEONOR-ZF14), and this was used as a thermoplastic resin in place of cellulose acylate. The additives in Table 3 are as follows: T1 is a polymer plasticizer shown in Table 2, P-64; T2 is TPP/BDP=1/1 (by weight); Table 3 is a compound mentioned below; T4 is a polymer plasticizer shown in Table 1, P-6.

### T3:

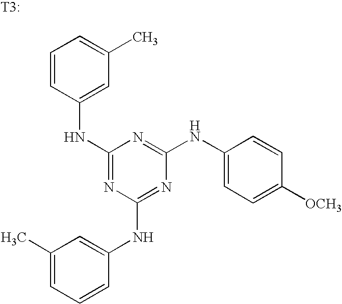

A film was produced, using a film production apparatus. The starting material dope was stirred with an in-line mixer to prepare a casting dope.

The casting drum was so controlled that the peripheral speed thereof in the drum running direction could be kept almost constant within a range of from 20 m/min to 100 m/min. The temperature of the peripheral surface of the casting drum was kept almost constant within a range of from 0° C. to 35° C.

Through the casting die, the casting dope was cast onto the surface of the casting drum thereby forming a cast film thereon. After the cast film became self-supporting, this was peeled away from the casting drum to be a wet film, using a scraping roller.

In order to prevent scraping failure, the scraping speed (scraping roller draw) relative to the speed of the casting drum was suitably controlled to fall within a range of from 100.1% to 110%. The wet film was transferred via the transfer zone to the tenter zone and the drying zone in order. In the transfer zone, the tenter zone and the drying zone, dry air was applied to the wet film for drying the film in a predetermined manner. The dried film was transferred to the cooling zone. In the cooling zone, the film was cooled to 30° C. or lower.

Next, the film was processed for discharging and knurling, and then transferred to the winding zone. In the winding zone, the film was wound up while desired tension was given thereto by a press roller. The film thus produced in the film production apparatus had a width of from 1300 to 2500 mm and a thickness of 70 μm.

### Examples 10, 12 and 13

### (Preparation of Cellulose Acylate Dope for Core Layer (C Layer))

| | |
|---|---|
| Cellulose acylate resin, shown in Table 3 | 100 parts by mass |
| Additive, shown in Table 3 | the amount shown in Table 3 |
| | (unit, part by mass) |
| Dichloromethane | 406 parts by mass |
| Methanol | 61 parts by mass |

### (Preparation of Cellulose Acylate Dope of Skin B Layer (SB Layer))

| | |
|---|---|
| Cellulose acylate resin, shown in Table 3 | 100 parts by mass |
| Additive, shown in Table 3 | the amount shown in Table 3 |
| | (unit, part by mass) |
| Mat agent | 0.05 parts by mass |
| Release promoter | 0.03 parts by mass |
| Dichloromethane | 406 parts by mass |
| Methanol | 61 parts by mass |

### (Preparation of Cellulose Acylate Dope of Skin A Layer (SA Layer))

| | |
|---|---|
| Cellulose acylate resin, shown in Table 3 | 100 parts by mass |
| Additive, shown in Table 3 | the amount shown in Table 3 |
| | (unit, part by mass) |
| Mat agent | 0.05 parts by mass |
| Dichloromethane | 406 parts by mass |
| Methanol | 61 parts by mass |

### (Matting Agent)

Nippon Aerosil's Aerosil 972 (trade name, silicon dioxide particles having a mean particle size of 15 nm and a Mohs hardness of about 7 manufactured by NIPPON AEROSIL CO., LTD.).

### (Release Promoter)

Partial ethyl ester of citric acid.

Next, using the dopes for the constitutive layers, a film was produced in the same manner as in Example 1 except for the following points.

The dopes were co-cast onto the running drum via the casting die, whereupon the casting amount of each dope was so controlled that the thickness of the low-substitution layer (core layer, C layer) could be the largest, thereby forming a cast film by the controlled multilayer co-casting mode.

Next, the cast film was peeled away from the casting drum to give a wet film, and this was dried and stretched in the transfer zone and the tenter zone. The film was transferred into the drying zone, in which the film was fully dried while held wound around a large number of rollers. Finally, the film was wound up in the winding zone to be a roll film. Regarding the thickness of the thus-produced films, the film of Example 10 was skin B layer (SB layer)/core layer (C layer)/skin A layer (SA layer) of 2 μm/66 μm/2 μm; the film of Example 12 was skin B layer (SB layer)/core layer (C layer)/skin A layer (SA layer) of 3 μm/42 μm/1.5 μm; and the film of Example 13 was skin B layer (SB layer)/core layer (C layer) of 2 μm/68 μm. The film width was 2000 mm in every case.

### (Stretching Treatment)

The films produced according to the above methods were stored in the supply zone of an off-line stretching apparatus. Using a supply roller, the film was supplied from the supply zone to the tenter zone. The residual solvent amount in each film of Examples and Comparative Examples in this stage is shown in Table 3. In the tenter zone, the polymer film was stretched. The draw ratio in stretching and the stretching temperature are shown in Table 3.

### (Wet Heat Treatment)

The stretched film was processed for dew condensation prevention treatment, wet heat treatment (steam contact treatment) and heat treatment in that order.

In the dew condensation prevention treatment, the film was exposed to dry air to thereby control the film temperature (100° C.) Tf0.

In the wet heat treatment (steam contact treatment), the absolute humidity in the wet vapor contact chamber (absolute humidity in wet heat treatment) was controlled as in Table 3, the dew point of the wet vapor was regulated to be higher by 10° C. than the temperature Tf0 of each film, and the film was transferred through the zone while the film temperature (wet heat treatment temperature) shown in Table 3 was kept as such for the processing period of time (60 seconds).

In the heat treatment, the absolute humidity in the heat treatment chamber (absolute humidity in heat treatment) was controlled to 0 g/m³, and the film was transferred through the zone while the film temperature (heat treatment temperature) was kept at the same as the wet heat treatment temperature for the processing period of time (2 minutes). The film surface temperature was measured as follows: A tape-type thermocouple surface temperature sensor (Anritsu Keiki's ST series) was stuck to 3 points of each film, and the data were averaged.

Next, the film was cooled to room temperature and would up. Thus, the films of Examples and Comparative Examples were obtained.

The thus-produced films were analyzed for Re, Rth, ΔRe and MD and TD dimensional change thereof, according to the test methods mentioned above. The results are shown in Table 3 below.

### (Peelability)

In peeling the cast film from the support to give the wet film in Examples and Comparative Examples (film peeling before stretching), the fluctuation width of the peeling point was measured to evaluate the peelability of the film.
A: Fluctuation width of peeling point, 0 mm with no fluctuation (extremely light).
B: Fluctuation width of peeling point, at most 2 mm with some fluctuation (light).
C: Fluctuation width of peeling point, at most 5 mm with some fluctuation (somewhat heavy).
C: Fluctuation width of peeling point, 10 mm or more with fluctuation (heavy).

Based on the data as above, the peelability was evaluated, and the results are shown in Table 3 below. The film in Comparative Example 3 was not tested for the peelability.

### [Formation of Polarizer]

The surface of the cellulose acylate film produced in Examples and Comparative Examples was alkali-saponified. The film was dipped in an aqueous 1.5 N sodium hydroxide solution at 55° C. for 2 minutes, then washed with water in a washing bath at room temperature, and neutralized with 0.1 N sulfuric acid at 30° C. Again, this was washed with water in a washing bath at room temperature, and dried with hot air at 100° C. Subsequently, a roll of a polyvinyl alcohol film having a thickness of 80 μm was unrolled and continuously stretched in an aqueous iodine solution by 5 times, and dried to give a polarizing element having a thickness of 20 μm. A film of Fujitac TD80UL (by FUJIFILM) was alkali-saponified in the same manner as above. Using an aqueous 3% polyvinyl alcohol (Kuraray's PVA-117H) solution as an adhesive, the above-mentioned alkali-saponified polymer film and the alkali-saponified film Fujitac TD80UL were stuck together via the polarizing element sandwiched therebetween in such a manner that the saponified surface of each film could be on the polarizing element side, thereby producing a polarizer. In the polarizer, the cellulose acylate film of Examples and Comparative Examples and TD80UL each serve as the protective film for the polarizing element. In this, the films were so stuck that the machine direction (MD) of the cellulose acylate film and the slow axis of TD80UL could be parallel to the absorption axis of the polarizing element.

### [Production of Liquid-Crystal Display Device]

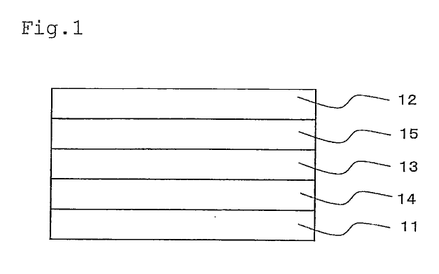

The polarizer and the retardation film on the surface and the back of a VA-mode liquid-crystal TV (KDL-32J5000, by Sony) were peeled away, and the liquid-crystal cell was used herein. As in the constitution shown in FIG. 1, an outer protective film (now shown), the polarizing element 11, the cellulose acylate film 14 of Examples or Comparative Examples, the liquid-crystal cell 13 (above VA-mode liquid-crystal cell), the optically anisotropic film (Fujitac TD80UL) 15, the polarizing element 12 and an outer protective film (not shown) were stuck to each other in that order with an adhesive, thereby constructing a liquid-crystal display device. In this, the films were so stuck that the absorption axes of the upper and lower polarizers could be perpendicular to each other.

The liquid-crystal display device was put in a thermo-hygrostat at 60° C. and 90% RH for 500 hours, then taken out, and kept at 25° C. and 60% RH for 24 hours. The thus-aged liquid-crystal display device was checked for the black brightness at a polar axis of 60° and at an azimuth angle of 45° at the time of black level of display, using a tester (EZ-contrast 160D, by ELDIM). This is referred to as oblique black brightness. Thus measured, the oblique black brightness was evaluated according to the following criteria. The results are shown in Table 3.
A from 0 cd/m² to less than 0.15 cd/m².
B from 0.15 cd/m² to less than 0.25 cd/m².
C from 0.25 cd/m² to less than 0.4 cd/m².
D 0.4 cd/m² or more.

TABLE 3

| | | Residual | | | | | | | | |
|---|---|---|---|---|---|---|---|---|---|---|
| | | Solvent | | | Total Degree of | Degree of Pr | | Additive | Stretching | Draw Ratio in |
| | | Amount | T[tanδ] | ΔTm | Substitution | Substitution | Type of | Amount | Temperature | Stretching |
| | Resin | (mas. %) | (° C.) | (° C.) | [A + B] | [B] | Additive | (mas. %) | (° C.) | (%) |
| Example 1 | CA | 0 | 200 | 0 | 2.10 | 0.0 | T1 | 20 | 190 | 30 |
| Example 2 | CA | 0 | 185 | 0 | 2.42 | 0.0 | T1 | 20 | 180 | 30 |
| Example 3 | CA | 0 | 175 | 0 | 2.65 | 0.0 | T1 | 20 | 170 | 30 |
| Example 4 | CAP | 0 | 185 | 0 | 2.10 | 0.5 | T2 | 11.5 | 170 | 30 |
| Example 5 | CAP | 0 | 175 | 0 | 2.42 | 0.6 | T2 | 11.5 | 165 | 30 |
| Example 6 | CAP | 0 | 165 | 0 | 2.65 | 0.7 | T2 | 11.5 | 155 | 30 |
| Example 7 | CA | 0 | 192 | 0 | 2.42 | 0.0 | T1 | 17 | 190 | 30 |
| | | | | | | | T3 | 1 | | |
| Example 8 | CA | 0 | 186 | 0 | 2.42 | 0.0 | T4 | 17 | 180 | 30 |
| Example 9 | CA | 0 | 178 | 0 | 2.42 | 0.0 | T4 | 20 | 180 | 30 |
| | | | | | | | T3 | 3 | | |
| Example 10 | CA | 0 | 178 | 0 | outer layer 2.81 | 0.0 | T1 | 10 | 178 | 32 |
| | CA | | | | core layer 2.42 | 0.0 | T1 | 20 | | |
| | CA | | | | outer layer 2.81 | 0.0 | T1 | 10 | | |
| Example 11 | CA | 40 | 186 | 32 | 2.42 | 0.0 | T1 | 18 | 156 | 30 |
| Example 12 | CA | 40 | 178 | 24 | outer layer 2.81 | 0.0 | T1 | 10 | 157 | 32 |
| | CA | | | | core layer 2.42 | 0.0 | T1 | 20 | | |
| | CA | | | | outer layer 2.81 | 0.0 | T1 | 10 | | |
| Example 13 | CA | 0 | 178 | 0 | core layer 2.42 | 0.0 | T1 | 20 | 165 | 28 |
| | CA | | | | outer layer 2.81 | 0.0 | T1 | 10 | | |
| Comparative | CA | 0 | 185 | 0 | 2.42 | 0.0 | T1 | 20 | 177 | 30 |
| Example 1 | | | | | | | | | | |
| Comparative | CA | 0 | 185 | 0 | 2.42 | 0.0 | T1 | 20 | 153 | 30 |
| Example 2 | | | | | | | | | | |
| Comparative | COP | 0 | 150 | 0 | — | — | — | — | 150 | 30 |
| Example 3 | | | | | | | | | | |
| Comparative | CA | 0 | 185 | 0 | 2.42 | 0.0 | T1 | 20 | 218 | 35 |
| Example 4 | | | | | | | | | | |
| Comparative | CA | 0 | 190 | 0 | 2.42 | 0.0 | T4 | 15 | 165 | 30 |
| Example 5 | | | | | | | T3 | 3 | | |
| Comparative | CA | 0 | 190 | 0 | 2.42 | 0.0 | T4 | 15 | 165 | 30 |
| Example 6 | | | | | | | T3 | 3 | | |
| Comparative | CA | 0 | 190 | 0 | 2.42 | 0.0 | T4 | 15 | 165 | 30 |
| Example 7 | | | | | | | T3 | 3 | | |
| Comparative | CA | 0 | 190 | 0 | 2.42 | 0.0 | T4 | 15 | 165 | 30 |
| Example 8 | | | | | | | T3 | 3 | | |

| | Wet Heat Treatment | | | | | Dimensional | Dimensional | | Oblique Black |
|---|---|---|---|---|---|---|---|---|---|
| | | Absolute | | | | Change | Change | | Brightness in |
| | Temperature | Humidity | Re | Rth | ΔRe | MD | TD | | Liquid-Crystal |
| | (° C.) | (g/cm³) | (nm) | (nm) | (nm) | (nm) | (nm) | Peelability | Display Device |
| Example 1 | 120 | 270 | 80 | 180 | 2.8 | −0.3 | −0.2 | D | not mounted |
| Example 2 | 120 | 270 | 60 | 124 | 3.6 | −0.2 | 0 | C | A |
| Example 3 | 120 | 270 | 25 | 67 | 3.5 | −0.1 | 0.1 | B | not mounted |
| Example 4 | 120 | 400 | 82 | 176 | 2.4 | −0.3 | −0.2 | D | not mounted |
| Example 5 | 120 | 400 | 55 | 110 | 3.4 | −0.2 | −0.2 | C | A |
| Example 6 | 120 | 400 | 29 | 76 | 3.6 | −0.1 | −0.1 | B | not mounted |
| Example 7 | 100 | 270 | 61 | 114 | 2.1 | −0.3 | −0.2 | C | B |
| Example 8 | 100 | 270 | 50 | 100 | 8.9 | −0.1 | 0.2 | C | A |
| Example 9 | 100 | 270 | 57 | 120 | 1.5 | −0.4 | 0 | C | B |
| Example 10 | 110 | 330 | 50 | 114 | 3.5 | −0.2 | −0.1 | A | A |
| Example 11 | 100 | 400 | 50 | 100 | 3.8 | −0.1 | 0.2 | C | A |
| Example 12 | 110 | 330 | 54 | 112 | 3.7 | −0.1 | −0.1 | A | A |
| Example 13 | 95 | 230 | 45 | 150 | 3.6 | −0.2 | −0.4 | A | A |
| Comparative | no | no | 58 | 120 | 3.2 | −0.6 | −0.4 | C | D |
| Example 1 | | | | | | | | | |
| Comparative | 110 | 330 | 62 | 165 | 2.5 | −0.8 | −1.7 | C | D |
| Example 2 | | | | | | | | | |
| Comparative | 100 | 350 | 52 | 110 | 0.3 | −0.3 | −0.2 | not tested | D |
| Example 3 | | | | | | | | | |
| Comparative | 110 | 330 | 13 | 42 | 3.8 | 0.6 | 0.5 | C | D |
| Example 4 | | | | | | | | | |
| Comparative | 55 | 275 | 50 | 132 | 3.2 | −0.4 | −1.2 | C | A |
| Example 5 | | | | | | | | | |
| Comparative | 140 | 400 | 88 | 96 | 3.1 | −1.6 | 0.1 | C | not mounted |
| Example 6 | | | | | | | | | |
| Comparative | 120 | 150 | 60 | 140 | 3.2 | −0.5 | −1.4 | C | A |
| Example 7 | | | | | | | | | |
| Comparative | 120 | 450 | 88 | 89 | 3.1 | −2.1 | 0.2 | C | not mounted |
| Example 8 | | | | | | | | | |

As in Table 3, the films of Examples of the invention all fall within the scope of the invention in point of the wavelength dispersion and the dimensional change thereof. In addition, their optical properties were all in preferred ranges.

On the other hand, for the film of Comparative Example 1, the wet heat treatment temperature and the absolute humidity in the wet heat treatment were outside the scope of the invention, and therefore, the dimensional change of the film was large. For the film of Comparative Example 2, the stretching temperature was lower than the lowermost limit in the invention, and therefore, the dimensional change of the film was large. For the film of Comparative Example 3, the resin used was outside the scope of the invention, and therefore, the wavelength dispersion was lower than the lowermost limit in the invention. For the film of Comparative Example 4, the stretching temperature was outside the scope of the invention, and therefore the dimensional change of the film was large, and in addition, the film was browned and was therefore unsuitable for optical films. In Comparative Examples 5 and 6, the wet heat treatment temperature was lower or higher than the lowermost limit or the uppermost limit in the invention, and therefore the dimensional change of the films was large. In Comparative Examples 7 and 8, the absolute humidity in the wet heat treatment was lower or higher than the lowermost limit or the uppermost limit in the invention, and therefore the dimensional change of the films was large.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2009-69700, filed on Mar. 23, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film of which the difference between the in-plane retardation at a wavelength of 630 nm and the in-plane retardation at a wavelength of 450 nm, ΔRe satisfies the following formula (1), and of which the dimensional change before and after a lapse of time of 24 hours at 60° C. and 90% RH satisfies the following formula (2) both in the film traveling direction and in the direction perpendicular thereto:
1 nm≦ΔRe≦15 nm (1)
−0.5%≦{(L′−L0)/L0}×100≦0.5% (2),
wherein L0 means the length of the film (unit, mm) before the lapse of time of 24 hours at 60° C. and 90% RH; and L′ means the length of the film (unit, mm) after the lapse of time of 24 hours at 60° C. and 90% RH followed by humidity conditioning for 2 hours.

2. The cellulose acylate film according to claim 1, of which the in-plane retardation Re at a wavelength of 590 nm satisfies the following formula (3):
30 nm≦Re≦70 nm (3).

3. The cellulose acylate film according to claim 1, of which the thickness-direction retardation Rth at a wavelength of 590 nm satisfies the following formula (4):
90 nm≦Rth≦300 nm (4)
Rth=((nx+ny)/2−nz)×d (4′),
wherein nx, ny and nz each mean the refractive index of an index ellipsoid in the respective main axial directions, and d means the thickness of the film.

4. The cellulose acylate film according to claim 1, of which the in-plane retardation Re at a wavelength of 590 nm satisfies the following formula (3), and of which the thickness-direction retardation Rth at a wavelength of 590 nm satisfies the following formula (4):
30 nm≦Re≦70 nm (3)
90 nm≦Rth≦300 nm (4)
Rth=((nx+ny)/2−nz)×d (4′),
wherein nx, ny and nz each mean the refractive index of an index ellipsoid in the respective main axial directions, and d means the thickness of the film.

5. The cellulose acylate film according to claim 1, wherein the degree of acyl substitution of the cellulose acylate in the cellulose acylate film satisfies the following formula (5):
2.3≦A+B≦2.6 (5)
wherein A means the degree of substitution with an acetyl group in the cellulose acylate; and B means the degree of substitution with a propionyl group or a butyryl group in the cellulose acylate.

6. The cellulose acylate film according to claim 5, wherein the degree of acyl substitution of the cellulose acylate in the cellulose acylate film satisfies the following formula (6):
0≦B≦1 (6),
wherein B means the degree of substitution with a propionyl group or a butyryl group in the cellulose acylate.

7. The cellulose acylate film according to claim 4, wherein the degree of acyl substitution of the cellulose acylate in the cellulose acylate film satisfies the following formulae (5) and (6):
2.3≦A+B≦2.6 (5)
0≦B≦1 (6),
wherein A means the degree of substitution with an acetyl group in the cellulose acylate; and B means the degree of substitution with a propionyl group or a butyryl group in the cellulose acylate.

8. The cellulose acylate film according to claim 1, wherein the film traveling direction is along the slow axis of the film.

9. The cellulose acylate film according to claim 1, which has a two-layered or more multilayered structure.

10. The cellulose acylate film according to claim 9, wherein the total degree of acyl substitution DSa in the layer of a cellulose acylate having the highest total degree of acyl substitution, and the total degree of acyl substitution DSb in the layer of a cellulose acylate having the lowest total degree of acyl substitution satisfy the following formula (7):
0.1≦DSa−DSb≦0.5 (7).

11. A method for producing a cellulose acylate film, which comprises stretching a cellulose acylate film at a temperature satisfying the following formula (8), followed by processing the stretched film for wet heat treatment under the condition satisfying the following formulae (9) and (10):
Te−30° C.≦(stretching temperature)≦Te+30° C. (8)
Te=T[tan δ]−ΔTm (8′)
ΔTm=Tm(0)−Tm(x) (8″),
wherein T[tan δ] means a temperature at which tan δ shows a peak, and tan δ means the dynamic viscoelasticity of the cellulose acylate in which the residual solvent amount is 0%; Tm(0) means the crystal melting temperature of the cellulose acylate in which the residual solvent amount is 0%; Tm(x) means the crystal melting temperature of the cellulose acylate in which the residual solvent amount is x %,
60° C.≦(wet heat treatment temperature)≦130° C. (9)
200 g/m³≦(absolute humidity in wet heat treatment)≦500 g/m³ (10).

12. The method for producing a cellulose acylate film according to claim 11, wherein the cellulose acylate film satisfies the following formula (5):
2.3≦A+B≦2.6 (5)
wherein A means the degree of substitution with an acetyl group in the cellulose acylate; and B means the degree of substitution with a propionyl group or a butyryl group in the cellulose acylate.

13. The method for producing a cellulose acylate film according to claim 12, wherein the cellulose acylate film satisfies the following formula (11):
B=0 (11),
wherein B means the degree of substitution with a propionyl group or a butyryl group in the cellulose acylate.

14. The method for producing a cellulose acylate film according to claim 13, wherein the cellulose acylate is stretched at a temperature satisfying the following formula (12):
Te−20° C.≦(stretching temperature)≦Te+20° C. (12)
Te=T[tan δ]×ΔTm (12′)
ΔTm=Tm(0)−Tm(x) (12″),
wherein T[tan δ] means a temperature at which tan δ shows a peak, and tan δ means the dynamic viscoelasticity of the cellulose acylate in which the residual solvent amount is 0%; Tm(0) means the crystal melting temperature of the cellulose acylate in which the residual solvent amount is 0%; Tm(x) means the crystal melting temperature of the cellulose acylate in which the residual solvent amount is x %.

15. The method for producing a cellulose acylate film according to claim 14, wherein the stretched cellulose acylate film is processed for wet heat treatment under the condition satisfying the following formulae (13) and (14):
70° C.≦(wet heat treatment temperature)≦120° C. (13)
250 g/m³≦(absolute humidity in wet heat treatment)≦400 g/m³ (14).

16. The method for producing a cellulose acylate film according to claim 11, wherein the stretched cellulose acylate subjected to the wet heat treatment is further processed for heat treatment under an absolute humidity of 0 g/m³ .

17. A cellulose acylate film produced by the method of claim 11.

18. A retardation film comprising at least one cellulose acylate film of which the difference between the in-plane retardation at a wavelength of 630 nm and the in-plane retardation at a wavelength of 450 nm, ΔRe satisfies the following formula (1), and of which the dimensional change before and after a lapse of time of 24 hours at 60° C. and 90% RH satisfies the following formula (2) both in the film traveling direction and in the direction perpendicular thereto:
1 nm≦ΔRe≦15 nm (1)
−0.5%≦{(L′−L0)/L0}×100≦0.5% (2),
wherein L0 means the length of the film (unit, mm) before the lapse of time of 24 hours at 60° C. and 90% RH; and L′ means the length of the film (unit, mm) after the lapse of time of 24 hours at 60° C. and 90% RH followed by humidity conditioning for 2 hours.

19. A polarizer comprising at least one cellulose acylate film of which the difference between the in-plane retardation at a wavelength of 630 nm and the in-plane retardation at a wavelength of 450 nm, ΔRe satisfies the following formula (1), and of which the dimensional change before and after a lapse of time of 24 hours at 60° C. and 90% RH satisfies the following formula (2) both in the film traveling direction and in the direction perpendicular thereto:
1 nm≦ΔRe≦15 nm (1)
−0.5%≦{(L′−L0)/L0}×100≦0.5% (2),
wherein L0 means the length of the film (unit, mm) before the lapse of time of 24 hours at 60° C. and 90% RH; and L′ means the length of the film (unit, mm) after the lapse of time of 24 hours at 60° C. and 90% RH followed by humidity conditioning for 2 hours.

20. A liquid-crystal display device comprising at least one cellulose acylate film of which the difference between the in-plane retardation at a wavelength of 630 nm and the in-plane retardation at a wavelength of 450 nm, ΔRe satisfies the following formula (1), and of which the dimensional change before and after a lapse of time of 24 hours at 60° C. and 90% RH satisfies the following formula (2) both in the film traveling direction and in the direction perpendicular thereto:
1 nm≦ΔRe≦15 nm (1)
−0.5%≦{(L′−L0)/L0}×100≦0.5% (2),
wherein L0 means the length of the film (unit, mm) before the lapse of time of 24 hours at 60° C. and 90% RH; and LT means the length of the film (unit, mm) after the lapse of time of 24 hours at 60° C. and 90% RH followed by humidity conditioning for 2 hours.
